(19) United States
(12) Patent Application Publication
(10) Pub. No.: US 2021/0318231 A1
(43) Pub. Date: Oct. 14, 2021

(54) Liquid Crystal-Based Detection of Air Contaminants Using Metal Surfaces

(71) Applicant: Wisconsin Alumni Research Foundation, Madison, WI (US)

(72) Inventors: Emmanouil Mavrikakis, Middleton, WI (US); Nicholas Abbott, Lansing, NY (US); Tibor Szilvasi, Madison, WI (US); Nanqi Bao, Ithaca, NY (US); Huaizhe Yu, Ithaca, NY (US); Jake Gold, Madison, WI (US)

(21) Appl. No.: 17/353,271

(22) Filed: Jun. 21, 2021

Related U.S. Application Data
(63) Continuation-in-part of application No. 17/179,539, filed on Feb. 19, 2021.
Application No. 17/179,539 is a continuation of application No. 16/244,194, filed on Jan. 10, 2019, now Pat. No. 10,928,306.
(60) Provisional application No. 62/615,493, filed on Jan. 10, 2018.

(51) Int. Cl. G01N 21/21; G01N 21/88; C09K 19/00; G01N 21/78; G01N 31/22

(52) U.S. Cl. CPC G01N 21/21; G01N 21/8806; C09K 19/00; G01N 2021/1704; G01N 31/223; G01N 2021/8848; G01N 21/783

(57) ABSTRACT

Liquid crystal-based devices for detecting a target contaminant in air, including hydrogen, nitrogen dioxide, ozone, ammonia or carbon monoxide, and methods of using such devices to detect the target contaminant are disclosed. Such devices have a substrate surface that includes one or more metals or metal alloys that is in contact with a liquid crystal composition. When the device is contacted with a sample that contains the target contaminant, an observed change in the orientational ordering of the liquid crystal signals the presence of the target contaminant. In the absence of the target contaminant, no change in orientational ordering occurs.

### CROSS REFERENCE TO RELATED APPLICATIONS

This application is a continuation-in-part of U.S. application Ser. No. 17/179,539, filed on Feb. 19, 2021; which is a continuation of U.S. application Ser. No. 16/244,194, filed on Jan. 10, 2019 and issued on Feb. 23, 2021 as U.S. Pat. No. 10,928,306; which claims the benefit of U.S. provisional Application No. 62/615,493, filed on Jan. 10, 2018. Each of these applications is incorporated by reference herein in its entirety.

### STATEMENT REGARDING FEDERALLY SPONSORED RESEARCH OR DEVELOPMENT

This invention was made with government support under W911NF-13-P-0030 and awarded by the ARMY/ARO and under DMR1435195, DMR1921696 and IIS1837812 awarded by the National Science Foundation. The government has certain rights in the invention.

### FIELD OF THE INVENTION

The disclosure relates generally to liquid crystal-based methods and devices for detecting contaminants in air, such as hydrogen, carbon monoxide, ammonia, nitrogen dioxide or ozone.

### BACKGROUND OF THE INVENTION

The presence of contaminants in air, such as hydrogen, carbon monoxide, ammonia, nitrogen dioxide or ozone, can present toxicity or other concerns. For example, at 4%-74% concentration in air or 4%-94% concentration in oxygen, hydrogen is explosive. Carbon monoxide is highly toxic, with the Occupational Health and Safety Administration (OSHA) setting a maximum short-term workplace exposure limit at 200 ppm CO for 5 minutes. Ozone is also highly toxic, with OSHA setting a maximum short-term workplace exposure limit at 0.3 ppm O₃ for 15 minutes. Ammonia is highly flammable, and toxic to the skin, lungs and eyes. OSHA has set a maximum short-term workplace exposure limit for ammonia at 35 ppm NH₃ for 15 minutes. Similarly, nitrogen dioxide is a respiratory toxin at relatively low concentrations and can present a significant health hazard with OSHA setting a maximum short-term workplace exposure limit at 1 ppm NO₂ for 15 minutes.

These contaminants include common pollutants produced by transportation or industry (e.g., CO and NO₂), as well as toxic or harmful gases produced in industry that can be dangerous if accidently exposed to air (e.g., H₂ and NH₃). Because of the knowns hazards, exposure to humans for each of these common contaminants is highly regulated. Monitoring and enforcing exposure limits requires accurate and readily deployable methods of detecting such contaminants in the environment. Ideally, contaminant sensors would be lightweight, be made of relatively inexpensive materials, and could operate without electric power. Contaminant sensors having these characteristics could be designed to be wearable, in order to protect workers from such gases in the workplace. Alternatively, contaminant sensors having these characteristics could be readily incorporated into unmanned aerial vehicles (UAVs) or unmanned ground vehicles (UGVs), facilitating detection on the battlefield or in an industrial plant without risk to human operators. There could be other applications for such sensors, including without limitation use in wireless sensor networks or use in home environments for indoor monitoring.

Current technologies used for contaminant detection include gas chromatography, chemical tubes, metal oxide sensors and electrical sensors. However, most conventional sensing technologies are too bulky and heavy to be integrated into a wearable badge-like sensor or to be placed onto a robotic device such as a mini UAV or UGV. Some such technologies, such as gas chromatography, require significant time for component separation, and cannot be easily used for continuously monitoring a given environment.

Liquid crystal (LC)—based sensor devices for detecting targeted agents are well-known in the art. Such devices may include thin films of nematic LCs supported on a chemically functionalized surface. Interactions between the functionalized surface and LCs result in long-range alignment of the LC molecules, which can be readily transduced via a range of methods, including optical and electrical methods.

A preferred embodiment of an optical method is to probe the LC transmission of polarized light. Observed changes in the alignment of the LC molecules may signal the presence of a targeted agent. For example, U.S. Pat. Pub. No. 2007/0004046, which is incorporated by reference herein in its entirety, discloses that dimethylmethylphosphonate, or DMMP, a simulant of sarin gas, a chemical weapon, induces a change from a homeotropic to a planar alignment in the orientation of 4-pentyl-4′-cyanobiphenyl (5CB) films or other nitrile containing LCs such as E7, in contact with aluminum (III) perchlorate salts decorated on solid surfaces.

Liquid crystal-based sensors are compact, lightweight, made of relatively inexpensive materials, and can operate without electrical power, making them ideal for the creation of wearable sensors, for introducing chemical sensor capabilities into UAVs and UGVs, as well for creating massive (and relatively low-cost) sensor networks. In some exemplary embodiments, such sensors work when the target analyte induces a detectable change in the orientation of the LC. In some such embodiments, the LC is disposed onto a metal surface. A wide range of chemical analytes can be detected using LC-based sensors, including nerve and blister agents, H₂S, and a range of volatile organic compounds (VOCs). However, no previously known LC sensor design incorporating a metal surface can be used to detect and/or quantify in ambient air any of the common contaminants hydrogen, carbon monoxide, ammonia, nitrogen dioxide or ozone by detecting a change in LC orientation, such as a change in the orientation of the tilt angle or easy axis of the LC.

Accordingly, there is a need in the art for an improved LC-based sensor design that can be used to successfully detect one or more of these contaminants in the environment.

### BRIEF SUMMARY

We have developed compositions of matter that permit liquid crystal-based sensing of hydrogen, carbon monoxide, ammonia, nitrogen dioxide or ozone, along with methods that permit identification of preferred compositions of matter for design of optimized liquid crystal-based sensors of hydrogen, carbon monoxide, ammonia, nitrogen dioxide or ozone. The disclosed devices and methods were developed out of combined computational and experimental approaches, based on quantum mechanics and experiments with LCs adsorbed on metal surfaces. We used this methodology to computationally screen metal surfaces for use in LC sensors and then to quickly but very accurately experimentally evaluate the computationally derived predictions. This approach has led us to discover designs of metal surfaces that permit the successful detection of these common contaminants using LCs, along with methods of tuning the designs to optimize detection of a given contaminant of interest.

Accordingly, in a first aspect, this disclosure encompasses a device for detecting one or more target analytes, where the target analyte is hydrogen, carbon monoxide, ammonia, nitrogen dioxide or ozone. The device includes (a) a substrate having a surface including a metal or metal alloy, and (b) a liquid crystal composition including one or more liquid crystals in contact with the substrate surface. The liquid crystal composition is capable of changing its orientational ordering when the target analyte comes in contact with the substrate surface.

In some embodiments, the substrate surface is capable of binding the liquid crystal composition strongly enough to cause homeotropic ordering of the liquid crystal composition when in contact with the substrate surface in the absence of the target analyte, but not when the target analyte is bound to the substrate surface.

In other embodiments, the substrate surface is capable of interacting with a chemical sensitizer that is capable of chemically reacting with the target analyte, such that the orientational ordering of the liquid crystal composition when in contact with the substrate surface in the presence of the chemical sensitizer and in the absence of the target contaminant is different than when in the presence of both the chemical sensitizer and the target analyte.

In some embodiments, the liquid crystal composition further includes a dopant. In some such embodiments, the dopant includes two phenyls or a phenyl and a pyridine. In other such embodiments, the dopant includes a carboxylic acid or carboxylate terminus.

In some such embodiments, the dopant concentration within the liquid crystal composition is from 0.001 mole % to 10.0 mole %.

In some embodiments, the device further incudes the chemical sensitizer in contact with the substrate surface. In some such embodiments, at least some of the chemical sensitizer is bound to the substrate surface. In some such embodiments, the bound chemical sensitizer binds dissociatively to the substrate surface. In some such embodiments, the chemical sensitizer is O₃, and at least a portion of the O₃ is dissociatively bound to the substrate surface.

In some embodiments, the liquid crystal composition is capable of changing its orientational ordering if it is contacted with a gas composition having a non-zero target analyte concentration of 1000 ppm or less, 200 ppm or less, 100 ppm or less, 50 ppm or less, 25 ppm or less, 10 ppm or less, or 1 ppm or less.

In some embodiments, the device further includes a gas composition that is in contact with the device. In some such embodiments, the gas composition does not include the target analyte(s). In some such embodiments, the liquid crystal composition exhibits homeotropic orientational ordering relative to the substrate surface.

In other such embodiments, the gas composition includes the target analyte(s). In some such embodiments, the liquid crystal exhibits planar orientational ordering relative to the substrate surface.

In some embodiments that include a gas composition that does not include the target analyte(s), the device further includes a chemical sensitizer. In some such embodiments, the liquid crystal composition exhibits planar orientational ordering relative to the substrate surface.

In some embodiments that include a gas composition that include the target analyte(s), the device further includes a chemical sensitizer. In some such embodiments, the liquid crystal composition exhibits homeotropic orientational ordering relative to the substrate surface.

In some embodiments, the substrate surface includes one or more noble metals or alloys of noble metals. In some such embodiments, the noble metals are gold, palladium, platinum, or alloys thereof. In some such embodiments, the noble metal alloy is an AuPd alloy.

In some embodiments the liquid crystal composition includes one or more of 5CB (4-n-pentyl-4′-cyanobiphenyl), 8CB (4-cyano-4′octylbiphenyl), PD (4-(4-pentylphenyl)-pyridine), a PCH series liquid crystal, CBCA (4-cyano-4-biphenylcarboxylic acid), or one or more fluorinated mesogens.

In some embodiments, the device further includes a means for observing the orientational ordering of the liquid crystal composition.

In a second aspect, this disclosure encompasses a method for detecting the presence of one or more target analytes in a sample, where the target analyte is hydrogen, carbon monoxide, ammonia, nitrogen dioxide or ozone. The method includes the steps of (a) contacting a device as described above in any of its embodiments with the sample, and (b) observing the orientational ordering of the liquid crystal composition in the device. An observed change in the orientational ordering of the liquid crystal composition indicates that the target analyte is present in the sample.

In some embodiments, the observed change in orientational ordering that indicates the presence of the target analyte in the sample is a change from homeotropic to planar orientational ordering relative to the substrate surface. In other embodiments, the observed change in orientational ordering that indicates the presence of the target analyte in the sample is a change from planar to homeotropic orientational ordering relative to the substrate surface.

In some embodiments, the sample is a gaseous composition. In some such embodiments, the gaseous composition is ambient air.

In some embodiments, the method further includes quantifying the amount of the target analyte in the sample. In some such embodiments, the quantity of target analyte in the sample is correlated with the speed or extent of the observed change in orientational ordering.

In a third aspect, this disclosure encompasses a method for optimizing a detection device as described above in any of its embodiments to maximize its selectivity for, sensitivity for, or detection speed for a given target analyte. The method includes the steps of (a) contacting the device with a composition that includes the target analyte; (b) observing the orientational ordering of the liquid crystal composition in the device to determine its selectivity for, sensitivity for, or detection speed for the target analyte; (c) altering the device in one or more ways; (d) contacting the altered device with a composition that includes the target analyte; and (e) observing the orientational ordering of the liquid crystal composition in the device to determine how its selectivity for, sensitivity for, or detection speed for the target analyte was changed.

In some embodiments, the altering step includes adding to the device a chemical sensitizer that is capable of interacting with the substrate surface and capable of chemically reacting with the target analyte.

In some embodiments where the device includes a chemical sensitizer that is capable of interacting with the substrate surface and that is capable of chemically reacting with the target analyte, the altering step includes changing the concentration and/or composition of the chemical sensitizer.

In some embodiments, the altering step includes adding one or more dopants to the liquid crystal composition.

In some embodiments where the device includes one or more dopants, the altering step includes changing the concentration and/or composition of the one or more dopants.

In some embodiments, the altering step includes changing the composition of the substrate surface. In some such embodiments, the substrate surface is changed by changing the composition and/or concentrations of the metal(s) that make up the substrate surface.

Further objects, features and advantages of the invention will be apparent from the following detailed description when taken in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosure will be better understood and features and aspects beyond those set forth above will become apparent when considering the following detailed description. The detailed description makes reference to the following figures.

FIG. 1 shows a series of six optical micrographs (cross-polarized images) of 4-n-pentyl-4′-cyanobiphenyl (5CB) disposed on a gold (Au, lower right image) or gold-palladium alloy (AuPd, other five images) surface, constrained by a transmission electron microscopy (TEM) grid. In the upper left image, the surface is 8 ML Pd on Au; in the upper center image, the surface is 1.3 ML Pd on Au; in the upper right image, the surface is 0.5 ML Pd on Au; in the bottom left image, the surface is 0.07 ML Pd on Au; in the bottom center image, the surface is 0.04 ML Pd on Au. Dark images indicate homeotropic anchoring (strong binding) of the LC to the surface, while bright images indicate planar anchoring (weak binding) of the LC to the surface.

FIG. 2 is a calculated phase diagram for hydrogen (H₂) detection using 5CB disposed on a palladium (Pd(111)) surface. Planar=bright image predicted under cross-polarizers; Homeotropic=dark image predicted under cross-polarizers. The left axis shows chemical potential of H₂ with corresponding pressure of H₂ at 300 K on the right axis. The bottom axis shows chemical potential of 5CB with top axis corresponding to pressure of 5CB at 300 K (experimental region is constrained to dash red vertical line). The orange circle indicates that 1 atm of H₂ is predicted to displace 5CB to obtain planar anchoring. While experiments show that detection at 100-1000 ppm is predicted (10⁻⁴-10⁻³ atm), this is within 0.1 eV to 0.2 eV of chemical potential of H₂ of the planar anchoring region on the phase diagram, which is within DFT error.

FIG. 3 is a schematic illustration of simulated atomic level structures showing the favored orientation of PhPhCN on a metallic Pd(111) surface with or without adsorbed hydrogen, PhPhCN is used as a 5CB surrogate. The top panel is a top view showing homeotropic anchoring of PhPhCN with 0 ML adsorbed H, and the bottom panel is a top view showing planar anchoring of PhPhCN with 1 ML adsorbed H.

FIG. 4 is a series of four cross-polarized images of 5CB on a 0.07 ML Pd on Au surface, compartmentalized with a TEM grid. Scale bars are 200 μm. Initially, the 5CB exhibits homeotropic ordering (leftmost panel). After 3 minutes of exposure to 1,000 ppm H₂ in N₂, the 5CB switches to planar ordering (second panel from left). The planar ordering is maintained through a subsequent 60 minute exposure to N₂ (third panel from left), but is reversed back to homeotropic ordering upon a subsequent ten-minute exposure to air (rightmost panel).

FIG. 5 is a schematic illustration of simulated atomic/molecular level structures showing the corresponding 5CB anchoring configuration changes demonstrated in FIG. 4 or in FIG. 6 upon adsorption of the hydrogen analyte unto the 0.07 ML Pd on Au surface. The 5CB LC molecules are shown as ovals, and the H analyte atoms are shown as cross-hatched circles.

FIG. 6 is a series of two cross-polarized images of 5CB on a 0.07 ML Pd on Au surface, compartmentalized with a TEM grid. Scale bars are 200 μm. Initially, the 5CB exhibits homeotropic ordering (left panel). After 10 minutes of exposure to 1,000 ppm H₂ in air, the 5CB switches to planar ordering (right panel).

FIG. 7 is a potential energy diagram of the multi-step reaction mechanism for H₂ oxidation on Pd(111) with a 2×2 unit cell.

FIG. 8 is a series of three cross-polarized images of 5CB on a 0.07 ML Pd on Au surface, compartmentalized with a TEM grid. Scale bars are 200 μm. Initially, the 5CB exhibits homeotropic ordering (left panel). After 30 minutes of exposure to 10 ppm NO₂ in N₂, the 5CB switches to planar ordering (center panel). The 5CB maintains planar ordering after subsequent exposure to air for 60 minutes (right panel).

FIG. 9 is a schematic illustration of simulated molecular level structures showing the corresponding 5CB anchoring configuration changes demonstrated in FIG. 9 upon adsorption of the NO₂ analyte unto the 0.07 ML Pd on Au surface. The 5CB LC molecules are shown as ovals, and the NO₂ analyte molecules are shown as cross-hatched circles.

FIG. 10 is a schematic illustration of simulated atomic level structures showing the favored parallel (planar) anchoring of 5CB on a metallic Pd(111) surface with 0.75 ML CO adsorbed (side view). PhPhCN is used as a 5CB surrogate. Parallel binding occurs in 6×4 unit cell and 1/12^{th} ML PhPhCN.

FIG. 11 shows three series of cross-polarized images of 5CB disposed on an 8 ML Pd on Au surface, exposed to three different regimens of CO in N₂. Initially, the 5CB exhibits homeotropic ordering (left panel in each series). This orientation is maintained after 60 minutes of exposure to 1,000 ppm CO in N₂ (top right panel). In contrast, the 5CB switches to planar ordering after exposure to 2% CO in N₂ for 20 minutes (center right panel), or after exposure to 99.9% CO in CO for 5 minutes (bottom right panel).

FIG. 12 shows a series of five cross-polarized images of 5CB disposed on a 0.07 ML Pd on Au surface, exposed over time to 1,000 ppm CO in N₂. Initially, the 5CB exhibits homeotropic ordering (0 seconds, left panel). The 5CB orientation switches to planar ordering over time (after 60 seconds—second panel from left; after 120 seconds—third panel from left; after 180 seconds—fourth panel from left; after 240 seconds—rightmost panel).

FIG. 13 shows two series of cross-polarized images of 5CB (top series) or 2 mol % PD in 5CB (bottom series) disposed on a 1.3 ML Pd on Au surface, exposed to 2% CO in N₂. The 5CB switches to planar ordering after exposure for about 30 minutes (upper right panel), and the PD in 5CB switches to planar ordering after exposure for about 40 minutes (lower right panel).

FIG. 14 shows two series of cross-polarized images of 5CB (top series) or 2 mol % PD in 5CB (bottom series) disposed on a 1.3 ML Pd on Au surface, exposed to 2% NH₃ in N₂. The 5CB switches to planar ordering after exposure (upper right panel), but the PD in 5CB maintains its original homeotropic ordering (lower right panel).

FIG. 15 shows a series of three cross-polarized images of 5CB (left panel), 2 mole % CSCHFPYD in 5CB (center panel), and 2 mol % PDM in 5CB (right panel) disposed on a 1.3 ML Pd on Au surface, exposed to 2% CO in N₂. All three exhibit planar ordering after exposure.

FIG. 16 shows a series of three cross-polarized images of 2 mol % C5CHMPYD in 5CB (left panel), 2 mole % PD in 5CB (center panel), and 2 mol % CSCHPYD in 5CB (right panel) disposed on a 1.3 ML Pd on Au surface, exposed to 2% CO in N₂. The first two exhibit planar ordering after exposure.

FIG. 17 shows a series of three cross-polarized images of 5CB (left panel), 2 mole % CSCHFPYD in 5CB (center panel), and 2 mol % PDM in 5CB (right panel) disposed on a 1.3 ML Pd on Au surface, exposed to 2% NH₃ in N₂. The first two exhibit planar ordering after exposure.

FIG. 18 shows a series of three cross-polarized images of 2 mol % C5CHMPYD in 5CB (left panel), 2 mole % PD in 5CB (center panel), and 2 mol % C5CHPYD in 5CB (right panel) disposed on a 1.3 ML Pd on Au surface, exposed to 2% NH₃ in N₂. All three maintain homeotropic ordering after exposure.

FIG. 19 shows a series of six cross-polarized images of 5CB disposed on a Pt surface. Initially, the 5CB exhibits homeotropic ordering (top left panel). Upon exposure to 2% ppm CO in N₂, the 5CB switches to planar ordering (top center panel). The 5CB maintains planar orientation on subsequent exposure to N₂ (top right panel), while reverting to homeotropic ordering upon subsequent exposure to air (bottom right panel). Further exposure to 2% ppm CO in N₂ causes the 5CB to switch back to planar ordering (bottom center panel), which is again reversed by further exposure to air (bottom left panel).

FIG. 20 is a graph showing the calculated coverage of chemisorbed O on Pt(111) as a function of O₃ pressure and temperature.

FIG. 21 is a series of two cross-polarized images of 5CB on a Pt surface. Initially, the 5CB exhibits homeotropic ordering (left panel). The 5CB exhibits planar ordering on an O₃-exposed Pt surface (right panel).

FIG. 22 is a potential energy diagram of the multi-step reaction mechanism for CO oxidation on Pt(111) by surface oxygen.

FIG. 23 is a schematic illustration of simulated atomic level structures showing conversion of parallel (planar) anchoring of 5CB on a metallic Pt(111) surface with 1 ML O adsorbed to perpendicular (homeotropic) anchoring of 5CB when adsorbed O is reduced to 0.25 (side view). PhPhCN is used as a 5CB surrogate.

FIG. 24 is a series of two cross-polarized images of 5CB on a Pt surface that has been pretreated with O₃ (PtOₓ). Initially, the pretreated 5CB exhibits planar ordering (left panel). After exposure to 200-1,000 ppm CO in N₂, the 5CB switches to homeotropic ordering (right panel).

FIG. 25 is a series of two cross-polarized images of 0.005 mol % CBCA in 5CB on an Au surface that is exposed to 1,300 ppm O₃ in N₂. Initially, the LC exhibits homeotropic ordering (left panel). After a one-minute exposure to O₃ in N₂, the LC switches to planar ordering (right panel).

FIG. 26 is a schematic illustration of simulated atomic/molecular level structures showing the corresponding LC anchoring configuration changes demonstrated in FIG. 27. The LC molecules are shown as ovals, and the O analyte atoms are shown as cross-hatched circles.

FIG. 27 is a series of two cross-polarized images of 5CB on a 0.07 ML Pd on Au surface that is exposed to air, N₂, 100% relative humidity, or 10 ppm DMMP. Initially, the 5CB exhibits homeotropic ordering (left panel), which is not affected by exposure to any of these reagents (right panel).

While the invention is susceptible to various modifications and alternative forms, specific embodiments are shown by way of example in the drawings and description. However, these descriptions of specific embodiments do not limit the invention to the particular forms disclosed. Instead, the intention is to cover all modifications, equivalents, and alternatives falling within the spirit and scope defined by the appended claims.

### DETAILED DESCRIPTION

### I. In General

This invention is not limited to the particular methodology, protocols, materials, and reagents described, as these may vary. The terminology used in this disclosure is for describing particular embodiments only, and it does not limit the scope of the present invention, which will be limited only by the language of the appended claims.

As used in this disclosure, the terms “one or more” and “at least one” are interchangeable. The terms “comprising”, “including”, and “having” are also interchangeable. When referring to the orientation of a liquid crystal or liquid crystal composition relative to a substrate surface, the terms “orientation”, “orientational ordering”, “ordering”, “configuration”, and “anchoring configuration” are used interchangeably.

Throughout this disclosure, the term “binding energy” may be used in certain situations to describe dissociative adsorption.

Unless defined otherwise, all technical and scientific terms used in this disclosure have the same meanings as commonly understood by one of ordinary skill in the art to which this disclosure belongs. All publications and patents specifically mentioned in this disclosure are incorporated by reference for all purposes, including for describing and disclosing the chemicals, instruments, statistical analysis and methodologies that are reported in the publications that might be used in connection with the disclosed methods and devices. All references cited in this disclosure are indicative of the level of skill in the art.

### II. The Invention

Nematic liquid crystals are materials with mobilities characteristic of liquids, but that are capable of organizing over distances of hundreds of micrometers. Past theoretical and experimental studies have established that the orientations of liquid crystals near an interface to a confining medium are dictated by the chemical and topographical structure of that interface. This so-called anchoring of liquid crystals by surfaces has found widespread use in the display industry and underlies the principles that are being developed for the detection of molecular and biomolecular events at interfaces. Specifically, a change in the chemical or topographical structure of an interface brought about by a chemical or biological species at a surface can give rise to new orientations of liquid crystals in contact with that surface. As liquid crystals are birefringent, these new orientations can be visualized under simple polarized microscopy.

This disclosure is based on our discovery that substrate surfaces incorporating one or more metals, such as gold, palladium, platinum or palladium/gold alloys, can be used in combination with a liquid crystal-containing composition to detect common air contaminants in a sample, such as carbon monoxide, nitrogen dioxide, ozone, ammonia or hydrogen gas. To our knowledge, this is the first report of using liquid crystal-based detection sensors or methods for detecting these contaminants.

In an exemplary embodiment, either before or after the metal substrate surface is exposed to a sample that may contain one or more of these contaminants, a liquid crystal-containing composition is disposed onto the metal substrate surface. If the liquid crystal-containing composition is disposed onto the substrate surface before exposure to the sample, the substrate surface may be exposed to the sample indirectly by exposure to the liquid crystal.

In the absence of the contaminant, the liquid crystal-containing composition exhibits relatively strong binding (and thus homeotropic orientational ordering) to the metal substrate surface. When the contaminant present in the sample contacts the metal substrate surface, the binding strength of the liquid crystal to the metal substrate surface is substantially reduced by the adsorption of the contaminant onto the metal substrate surface. This occurs when the binding strength of the contaminant for the metal substrate surface is greater than the binding strength of the liquid crystal for the same metal substrate surface. This results in a detectable change of the orientational ordering of the liquid crystal (typically from homeotropic to planar), and this change signals the presence of the contaminant in the sample.

A. Using One or More Dopants to Increase Sensitivity and/or Selectivity

To increase the selectivity and/or sensitivity of the detector to a specific target contaminant, the liquid crystal-containing composition may include a dopant that is soluble within the liquid crystal host, but that may or may not itself be mesogenic. In some such embodiments, the dopant has a higher binding strength for the metal substrate surface than the liquid crystal host, thus facilitating increased selectivity for a given target contaminant.

For example, if the target contaminant has a binding strength for the metal substrate surface that is greater than both the host liquid crystal and the dopant, the target contaminant should be detectable using the composition containing both the host liquid crystal and the dopant, as described above. If the dopant binding strength for the metal substrate surface is greater than the binding strength of both the liquid crystal host and a potentially competitive contaminant that is not the target contaminant, it may also effectively prevent the non-target contaminant from binding to the metal substrate surface and triggering a “false positive” change in the orientational ordering of the liquid crystal, thus increasing the selectivity of the device for the target analyte.

Non-limiting examples of potential dopants include a variety of substituted and non-substituted toluenes, other biphenyls, and derivatives thereof. Both the specific dopant used and the concentration of the dopant in the liquid crystal-containing composition can be tuned to maximize the sensitivity and selectivity of detection for the target contaminant.

In some embodiments, the dopant concentration in the liquid crystal composition can range from about 0.001 to about 10 mole % dopant. As non-limiting examples, the dopant concentration may be about 0.001, 0.002, 0.003, 0.004, 0.005, 0.006, 0.007, 0.008, 0.009, 0.010, 0.011, 0.012, 0.013, 0.014, 0.015, 0.016, 0.017, 0.018, 0.019, 0.02, 0.03, 0.04, 0.05, 0.06, 0.07, 0.08, 0.09, 0.10, 0.11, 0.12, 0.14, 0.15, 0.16, 0.17, 0.18, 0.19, 0.20, 0.21, 0.22, 0.23, 0.24, 0.25, 0.26, 0.27, 0.28, 0.29, 0.30, 0.32, 0.34, 0.36, 0.38, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7. 2.8. 2.9. 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9 or 10.0 mole % dopant.

In some embodiments, the dopant concentration may fall within a range having a lower boundary of about 0.001, 0.002, 0.003, 0.004, 0.005, 0.006, 0.007, 0.008, 0.009, 0.010, 0.011, 0.012, 0.013, 0.014, 0.015, 0.016, 0.017, 0.018, 0.019, 0.02, 0.03, 0.04, 0.05, 0.06, 0.07, 0.08, 0.09, 0.10, 0.11, 0.12, 0.14, 0.15, 0.16, 0.17, 0.18, 0.19, 0.20, 0.21, 0.22, 0.23, 0.24, 0.25, 0.26, 0.27, 0.28, 0.29, 0.30, 0.32, 0.34, 0.36, 0.38, 0.4. 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7. 2.8. 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, mole % dopant, and having an upper boundary of about 0.002, 0.003, 0.004, 0.005, 0.006, 0.007, 0.008, 0.009, 0.010, 0.011, 0.012, 0.013, 0.014, 0.015, 0.016, 0.017, 0.018, 0.019, 0.02, 0.03, 0.04, 0.05, 0.06, 0.07, 0.08, 0.09, 0.10, 0.11, 0.12, 0.14, 0.15, 0.16, 0.17, 0.18, 0.19, 0.20, 0.21, 0.22, 0.23, 0.24, 0.25, 0.26, 0.27, 0.28, 0.29, 0.30, 0.32, 0.34, 0.36, 0.38, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7. 2.8. 2.9, 3.0, 3.1, 3.2, 3.3, 3.4, 3.5, 3.6, 3.7, 3.8, 3.9, 4.0, 4.1, 4.2, 4.3, 4.4, 4.5, 4.6. 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9 or 10.0 mole % dopant.

B. Using One or More Chemically Reactive Chemical Sensitizers to Increase Sensitivity and/or Selectivity

To increase the sensitivity and/or selectivity of the detector to a specific target contaminant, an agent that can interact with the substrate surface and that is chemically reactive with the target contaminant (a chemical sensitizer) may be contacted with the metal substrate surface before or while detection of the target contaminant is attempted.

In some such embodiments, the chemical sensitizer has a higher binding strength for the metal substrate surface than the liquid crystal, and thus would prevent binding of the liquid crystal to the metal substrate, resulting in an initial planar ordering. In the presence of the target contaminant, the chemical sensitizer chemically reacts with the target contaminant, resulting in a product or products that do not bind as strongly to the metal substrate surface as the chemical sensitizer, the target contaminant, or both. Accordingly, upon contact and reaction of the chemical sensitizer with the target contaminant, the resulting product(s) are released from the metal substrate surface, freeing binding sites for the liquid crystal to bind, resulting in a detectable change in liquid crystal ordering (in this case, from planar to homeotropic).

In a non-limiting example described in more detail in Example 8 below, the metal substrate surface in contact with the LC is pretreated with ozone (the chemical sensitizer), which binds to the substrate surface as dissociated oxygen atoms. With the oxygen atoms covering the metal substrate surface, the liquid crystal does not bind to the surface, resulting in a planar LC orientation. When carbon monoxide (the target contaminant) is added, it is oxidized to carbon dioxide, and the surface oxygen is reduced accordingly and released from the metal substrate surface, resulting in a detectable change in liquid crystal orientation (in this case, from planar to homeotropic), as binding sites are freed and occupied by LC. In other embodiments, a different target contaminant could be used, such as another reducing agent (e.g., H₂ or N₂). These are just a few non-limiting examples illustrating how the disclosed LC-based detection devices and methods can be made more sensitive and/or selective using a chemical reaction between the target contaminant and a chemical sensitizer.

C. Designing the Metal Substrate Surface to Optimize Sensitivity and/or Selectivity

To increase the sensitivity and/or selectivity of the detector to a specific target contaminant, the composition of the metal substrate may be specifically designed to optimize one or more of the relevant binding strengths. Non-limiting examples of binding strengths that could be optimized include the binding strength of the target contaminant to the substrate surface, the binding strength of potentially competitive non-target contaminants to the substrate surface, the binding strength of one or more dopants to the substrate surface, the binding strengths of the liquid crystal used to any of the system components, the binding strength of one or more chemical sensitizers to the substrate surface, or the binding strength of one or more products of the reaction between the target contaminant and a chemical sensitizer to the substrate surface.

Non-limiting examples of specific metal surface design choices include the metal or metal alloy used, the composition of the base metal layer and any metal layers deposited onto the base layer, the extent of metal deposition onto the base layer (e.g., thickness and/or percent coverage of the deposited layer(s)), the nature of the metal lattice, metal strain and/or ligand effects. As the skilled artisan would recognize, metal surface composition is constantly in flux, and the substrate surface can be further tuned to account for the dynamic nature of the substrate surface composition.

### D. Liquid Crystals

The term “liquid crystal,” as used in this disclosure, refers to an organic composition in an intermediate or mesomorphic state between solid and liquid. Suitable liquid crystals for use in the present invention include, but are not limited to, thermotropic liquid crystals. The disclosed methods and devices may employ polymeric liquid crystals, composite materials comprising particles and liquid crystals, or polymers and liquid crystals, as well as elastomeric liquid crystals. The disclosed methods and devices may also use liquid crystalline gels, including colloid-in-liquid crystal gels and molecular liquid crystalline gels containing, for example, gelators comprised of derivatives of amino acids. In certain embodiments of the disclosed methods and devices, the liquid crystal phase can include a low molecular weight liquid crystal, a liquid crystal elastomer, a liquid crystalline gel, or a liquid crystal droplet. The liquid crystal may also contain a chiral additive to create a cholesteric phase.

An example of a liquid crystalline elastomer is synthesized from the mesogen M₄OCH₃ and polymethylhydrosiloxane, according to A. Komp and coworkers “A versatile preparation route for thin free standing liquid single crystal elastomers” Macromol. Rapid Commun, 26: 813-818, 2005. Other LC elastomers suitable for use in the current disclosure are described by Deng in “Advances in liquid crystal elastomers” (Progress in Chemistry, 18 (10): 1352-1360, 2006), and in the documents cited by Deng. The scope of this disclosure also includes the use of liquid crystalline hydrogels, as described by Weiss, F. and Finkelmann H. in Macromolecules; 37(17); 6587-6595, 2004, and in the documents cited by Weiss and Finkelmann. Other embodiments use a composite comprising a dispersion of solid particulates, such as but not limited to microspheres, mixed with liquid crystal. Such composites are known by those skilled in the art to form a gel.

Other classes of liquid crystals that may be used in accordance with the disclosed devices and methods include, but are not limited to: polymeric liquid crystals, thermotropic liquid crystals, lyotropic liquid crystals, columnar liquid crystals, nematic discotic liquid crystals, calamitic nematic liquid crystals, ferroelectric liquid crystals, discoid liquid crystals, liquid crystal mixtures, bent-core liquid crystals, liquid crystals that are achiral to which a chiral sensitizer molecule was added, and cholesteric liquid crystals. Examples of just some of the liquid crystals that may be used are shown in Table 1. Additional non-limiting examples include 4-(4-pentylphenyl)-pyridine (PD), PCH series LCs, such as PCH5 (4-(trans-4′-pentylcyclohexyl)-benzonitrile), and fluorinated mesogens, such as TL205 (a mixture of cyclohexane-fluorinated biphenyls and fluorinated terphenyls). In some embodiments, the TL205 may be doped with PD.

In some exemplary embodiments, the liquid crystal is a nematic CB series liquid crystal, such as 4-pentyl-4′-cyanobiphenyl (5CB):

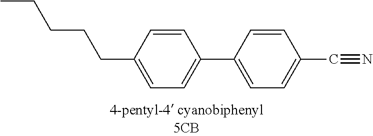 [SMILES: CCCCCc1ccc(-c2ccc(C#N)cc2)cc1]

TABLE 1
Molecular Structure of Mesogens Suitable for Use in the Disclosed Methods and Devices.

| Mesogen | Structure |
|---|---|
| Anisaldazine | 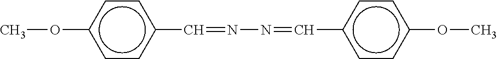 |
| NCB | 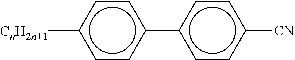 |
| CBOOA | 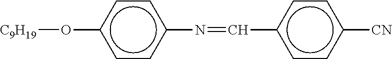 |
| Comp A | 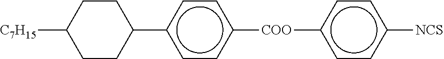 |
| Comp B | 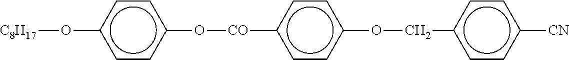 |
| DB₇NO₂ | 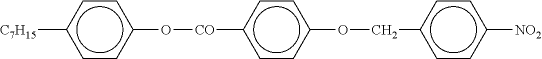 |
| DOBAMBC | 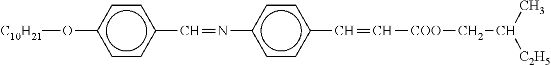 |
| nOm n = 1, m = 4: MBBA n = 2, m = 4: EBBA | 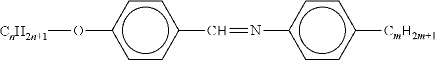 |
| nOBA n = 8: OOBA n = 9: NOBA | 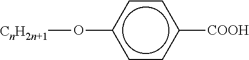 |
| nmOBC | 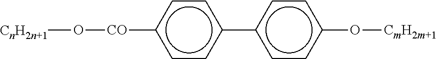 |
| nOCB | 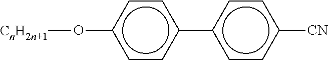 |
| nOSI | 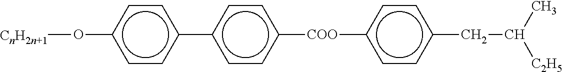 |
| 98P | 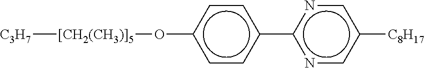 |
| PAA | 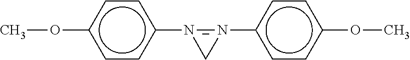 |
| PYP906 | 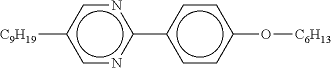 |
| ñSm | 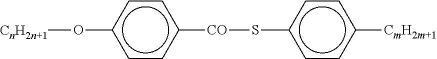 |

As is known to those skilled in the art, changes in the orientational order of the liquid crystal can lead to a change in the optical properties of the liquid crystal. Such changes can be detected and quantified by using optical instrumentation such as, but not limited to, plate readers, cameras, scanners, and photomultiplier tubes. Because the dielectric properties of liquid crystals also change with orientational order, measurements of electrical properties of liquid crystals can also be used to report changes in the orientational order of the liquid crystals. Thus a wide range of optical and electrical methods for observing the change in orientational order of liquid crystals is encompassed by this disclosure.

For example, in certain embodiments, the step of observing the orientational ordering of the liquid crystal at the interface is performed by detecting plane polarized light that is passed through the interface or liquid crystal surface. In some such embodiments, the plane polarized light is passed through the interface between crossed polarizers. Homeotropic ordering can be shown by observing the absence of transmitted light between cross-polarizers, and can be confirmed by an interference pattern consisting of two crossed isogyres under conoscopic examination. Planar ordering results in bright colored appearance when viewed between cross-polarizers.

In some embodiments of the disclosed methods and devices, the orientational ordering of the liquid crystal undergoes change over time, as the contaminant is introduced into the system. Thus, there is a transitional orientational ordering state between the planar orientation (parallel to the LC interface or surface) and the homeotropic orientation (perpendicular to the LC interface or surface). The transitional ordering is indicated by the so-called “tilt angle,” which is the angle at which the LC is oriented as compared to the surface normal (a vector perpendicular to the surface). A change in orientation of the LC can also involve a change in the azimuthal orientation.

The following examples are for illustrative purposes only, and do not limit the scope of the invention in any way. Indeed, various modifications of the invention in addition to those shown and described herein will become apparent to those skilled in the art from the foregoing description and the following example and fall within the scope of the appended claims.

### III. Examples

### Example 1

### General Computational Methods and Overview of Metal Surfaces for Liquid Crystal Sensors

Computational Methods.

Density Functional Theory (DFT) calculations were used to calculate binding energies and binding free energies supporting binding simulations of liquid crystals and analytes to metal surfaces. These calculations and simulations then guided the experiments providing “proof of concept” for the disclosed devices and methods.

All calculations were performed using DFT, as implemented in the Vienna Ab initio Simulation Package (VASP) code. Projector augmented wave potentials were used to describe the electron-ion interactions, and the exchange-correlation functional was described by the generalized gradient approximation (GGA-PBE). Dispersion corrections were used in all calculations employing Grimme's D3 empirical dispersion correction scheme with zero damping. The electron wave function was expanded using plane waves with an energy cutoff of 400 eV. The Brillouin zone (BZ) of each metal substrate was sampled using (4×4×1) Γ-centered Monkhorst-Pack k-point mesh for (4×4) unit cells, (6×6×1) Γ-centered Monkhorst-Pack k-point mesh for (2×2) unit cells, and (2×4×1) Γ-centered Monkhorst-Pack k-point mesh for (6×4) unit cells. In all calculations, the Methfessel-Paxton smearing method was used with 0.03 eV smearing. Structures were relaxed until the Hellmann-Feynman forces acting on each atom were less than 0.02 eV Å⁻¹. Spin polarized calculations were used for NO₂ gas and adsorbed agent calculations.

LC Surrogate to Metal Binding Calculations.

To reduce computational costs, PhPyr, which has the chemical formula:

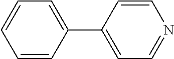 [SMILES: c1ccc(-c2ccncc2)cc1]

and PhPhCN, which has the chemical formula:

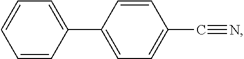 [SMILES: N#Cc1ccc(-c2ccccc2)cc1]

were used in our calculations and simulations.

The binding energy (BE) of an adsorbate is defined by BE=Eₜₒₜₐₗ−E_{substrate}−E_{gas}μₚₕₐₛₑ adsorbate where Eₜₒₜₐₗ is the total energy of the entire adsorbate-metal system with adsorbate adsorbed on the surface, E_{substrate} is the total energy of the clean metal itself, and E_{gas-phase adsorbate} is the total energy of the isolated adsorbate in the gas phase. By this definition, a more negative BE value reflects a stronger binding to the surface.

The binding free energy per unit area (BFEA) is defined by BFEA=(Gₜₒₜₐₗ−E_{substrate}−N_{gas}μ_{gas})/A where Gₜₒₜₐₗ is the total Gibbs free energy of the entire adsorbate-metal system with the adsorbate adsorbed on the surface, E_{substrate} is the total energy of the clean metal itself, N_{gas} is the total number of gas phase adsorbate molecules per slab, μ_{gas} is the chemical potential of the gas phase species, A is area of the metal surface. By this definition, a more negative BFEA value reflects a stronger binding to the surface.

When liquid crystals bind strongly to a metal surface, the liquid crystals exhibit the initial homeotropic anchoring used in most (but not all) of the detection schemes presented in these examples. As seen in Table 1, LC binds more weakly (i.e., it has a less negative binding energy in the bound state) to a gold surface than to a palladium or a platinum surface. This prediction was confirmed experimentally, with PhPhCN on a gold surface exhibiting planar ordering, while the other surrogate-metal combinations listed in Table 1 exhibited homeotropic ordering. The metal surfaces were modeled using the most stable (111) facet, and surrogate binding was modeled using 1/16 coverage of the surrogate on a 4×4 unit cell. All calculations used PBE-D3 level of theory in VSAP.

TABLE 1
Binding Energies of LC Surrogates on Au, Pd and Pt Surfaces
Binding Energies (eV)

| Adsorption Equation | Au(111) | Pd(111) | Pt(111) |
|---|---|---|---|
| PhPhCN(g) → PhPhCN_{⊥}* | −0.45 | −1.03 | −1.20 |
| PhPyr → PhPyr_{⊥}* | −0.92 | −1.41 | −1.74 |

*refers to surface bound species
Italics-experimentally confirmed to be planar (dark images)
Bold-experimentally confirmed to be homeotropic (dark image)

Air Contaminants to Metal Binding Calculations.

If a potential analyte, such as an air containment, has a substantially more negative binding energy on a given metal surface than a liquid crystal, it should be capable of displacing the liquid crystal on the metal surface, resulting (on exposure to the analyte) in a detectable change in the liquid crystal orientation from homeotropic to planar.

The binding energies of each of five common air contaminants (H₂, NO₂, CO, NH₃ and O₃) and a normal component of air (H₂O) were calculated for the three metal surfaces listed in Table 1 (Au, Pd and Pt). Again, the metal surfaces were modeled using the (111) facet, and analyte binding was modeled using ¼^{th} coverage of the analyte on a 2×2 unit cell. All calculations used PBE-D3 level of theory in VASP. Results are shown in Table 2.

TABLE 2
Adsorption Energies of Five Common Air Contaminants
and Water Vapor on Au, Pd and Pt Surfaces
Adsorption Energies (eV)

| Adsorption Equation | Au(111) | Pd(111) | Pt(111) |
|---|---|---|---|
| H₂ (g) + * → 2H* | +0.33 | −1.21 | −0.90 |
| NO₂ (g) + * → NO₂* | −1.01 | −1.58 | −1.44 |
| CO (g) + * → CO* | −0.43 | −2.27 | −2.05 |
| NH₃ (g) + * → NH₃* | −0.63 | −1.07 | −1.22 |
| O₃ (g) + * → O* +O₂(g) | −1.41 | −2.85 | −2.46 |
| H₂O (g) + * → H₂O* | −0.31 | −0.47 | −0.43 |

*refers to surface bound species
Italics-experimentally confirmed no response
Bold-experimentally confirmed response

As seen in Table 2, water vapor has a relatively low (less negative) binding energy with all three metals as compared to the PhPhCN surrogate. Thus, it should not be capable of displacing LC on any of these surfaces. This was confirmed experimentally, where exposure of a homeotropic LC on these metal surfaces to water vapor did not result in a change of LC orientation.

As further seen in Table 2, H₂, CO and NH₃ all have relatively low (less negative) adsorption (molecular/dissociative) energies with gold. Thus, these potential analytes should not be capable of displacing LC on gold surfaces. This was confirmed experimentally, where exposure of a LC on gold surfaces to these three potential analytes did not result in a change of LC orientation.

As further seen in Table 2, O₃ has a relatively high (more negative) adsorption energy with gold as compared to the PhPhCN surrogate. Thus, this potential analyte should be capable of displacing LC on gold surfaces. This was confirmed experimentally, where exposure of a LC on gold surface to O₃ resulted in a change of LC orientation.

As further seen in Table 2, H₂, NO₂, CO and NH₃ all have relatively high (more negative) adsorption energies with palladium as compared to the PhPhCN surrogate. Thus, these potential analytes should be capable of displacing LC on Pd surfaces. This was confirmed experimentally, where exposure of a homeotropic LC on Pd surfaces to these four potential analytes resulted in a change of LC orientation.

As further seen in Table 2, H₂ and CO have relatively high (more negative) adsorption energies with platinum. Thus, these potential analytes should be capable of displacing LC on Pt surfaces. This was confirmed experimentally, where exposure of a homeotropic LC on Pt surfaces to these two potential analytes resulted in a change of LC orientation.

In sum, these calculations and corresponding experiments demonstrate that liquid crystals bind strongly to metal surfaces, giving the initial homeotropic anchoring used in most detection schemes. These metal surfaces bind even more strongly to many of the potential analytes (i.e., common air contaminants) we are interested in detecting. Notably, these metal surfaces do not respond to water, even at 100% relative humidity. Thus, this common component of ambient air would not interfere with LC-based detection of air contaminants.

### Example 2

### Liquid Crystal Binding to AuPd Alloy Surfaces and General Experimental Methods

In the example, we extended our binding/adsorption energy calculations and corresponding experiments to Au/Pd alloy surfaces, and our results show that such alloy surfaces can be used in LC-based systems and methods for detecting air contaminants.

First, we calculated binding energies of the PhPhCN surrogate to two different AuPd alloys, Pd_{ML}Au(111) (a full monolayer (ML) of Pd deposited on a gold film) and Pd_{0.07ML}Au(111) (0.07 ML of Pd deposited on a gold film). Table 3 shows the results, along the previously reported results for Pd(111) and Au(111).

TABLE 3
Binding Energies of PhPhCN on Au, Pd and AuPd Alloy Surfaces
Binding Energy (eV) of LC molecule at
low surface coverages ( 1/16^{th} coverage)

| Molecule | Pd(111) | Pd_{ML}Au(111) | Pd_{0.07ML}Au(111) | Au(111) |
|---|---|---|---|---|
| Perpendicular | −1.03 | −1.11 | −0.97 | −0.45 |
| PhPhCN | | | | |

Strongly binding LC (<−0.6 eV) leads to homeotropic LC anchoring on the surface. As seen in Table 3, PhPhCN binds weakly to Au(111), but strongly to Pd(111). The DFT predictions suggest that homeotropic anchoring of LC can be achieved by creating alloys between Pd and Au.

### General Methods Used for LC Anchoring Experiments.

Glass slide preparation. Glass microscope slides were cleaned according to published procedures using acidic “piranha” solution [70 volume % of H₂SO₄ (98 weight % water solution)+30 volume % H₂O₂ (30 weight % water solution)]. Briefly, the glass slides were immersed in an acidic piranha bath at 60-80° C. for at least 1 h, and then rinsed in running deionized water for 2-3 min. The slides were then immersed in basic piranha [70 volume % of KOH (45 weight % water solution)+3 volume % H₂O₂ (30 weight % water solution)] and heated to between 60 and 80° C. for at least 1 h. Finally, the slides were rinsed sequentially in deionized water, ethanol, and methanol, and then dried under a stream of nitrogen. The clean slides were stored in an oven at 110° C. All other glassware was rinsed with distilled water and ethanol and dried under a gaseous stream of nitrogen.

Deposition of thin layers of gold. Semi-transparent films of gold with thicknesses of 200 Å were deposited onto piranha-cleaned glass slides mounted on a fixed holder within an electron beam evaporator (VEC-3000-C manufactured by Tekvac Industries, Brentwood, N.Y.). A layer of titanium (thickness 20 Å) was used to promote adhesion between the glass microscope slides and the films of gold. The rates of deposition of gold and titanium were 0.2 Å/s. The pressure in the evaporator was maintained at less than 3×10′ Torr before and during each deposition. The gold source was periodically cleaned by sequential immersion in aqua regia (70 volume % HNO₃, 30 volume % HCl) and piranha solutions at 50° C. (30 min in each solution); see above for compositions. The cycle was repeated 3-4 times, rinsing the source between cycles in deionized water.

Deposition of Pd on Au to make alloy surface. Pd was deposited on Au to the desired thickness by conventional electrochemical deposition, including underpotential deposition methods.

Formation of Micrometer-Thick Films of LC.

After coating the surfaces, as described above, an 18 μm-thick transmission electron microscopy (TEM) grid (Electron Microscopy Sciences, Hatfield, Pa.) was fastened to the coated surface. The TEM grid defined square pores with lateral dimensions of 285 μm. The grid had an overall diameter of 3 mm. The grids were filled with LC using a microcapillary tube at room temperature, taking care to fill only the middle squares of the TEM grid, so as to avoid wicking of the 5CB.

Exposure to Analytes (as Reported in Subsequent Examples).

The devices containing a liquid crystal composition disposed onto the metal substrate surface were exposed to a stream of nitrogen or air containing the indicated concentration of analyte within a flow cell that was constructed to direct the flow of air across the LC composition, while permitting simultaneous observation of the samples through a polarized light microscope (CH40, Olympus, Melville, N.Y.). Unless otherwise indicated, the relative humidity (RH) of the air or N₂ was controlled using a portable dew point generator (LI-610, LI-COR Biosciences, Lincoln, Nebr.). The temperature of the gas fed to the flow cell was maintained at room temperature (25° C.).

Characterization of Orientations of LCs in Optical Cells: We measured the orientations of LCs by fabricating optical cells from two gold surfaces that were aligned facing each other and spaced apart using a glass spacer with a diameter of 5 μm. Next, 2 μL of 5CB, heated to form an isotropic phase (35° C.<T<40° C.), was drawn into the cavity between the two surfaces of the optical cell by capillarity. The optical appearance of the LC film so-formed was characterized by using an Olympus BX-60 polarizing light microscope in transmission mode (Olympus, Japan). Conoscopic imaging of the LC films was performed by inserting a Bertran lens into the optical path of a polarized-light microscope to distinguish between homeotropic and isotropic films.

Experimental Demonstration of Nitrile-Containing LC (5CB) Anchoring on AuPd Alloy Surfaces

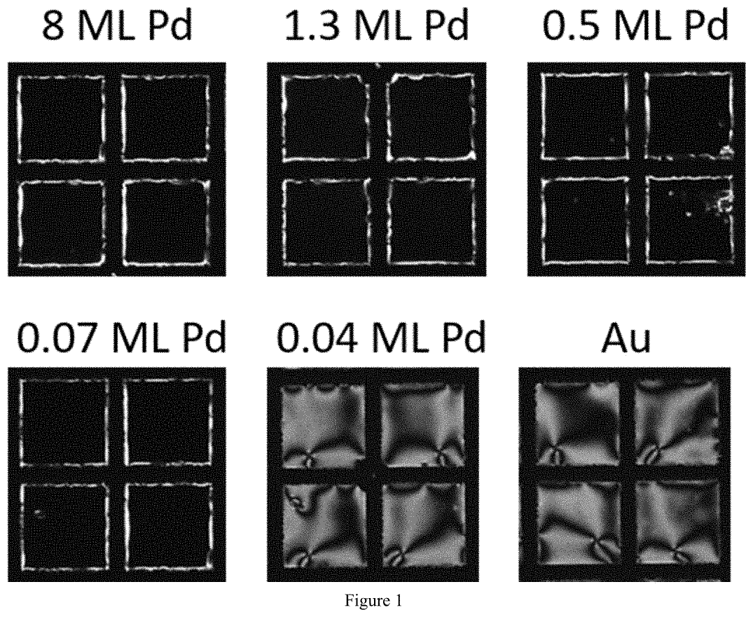

AuPd alloy was synthesized by first depositing the Au substrate by e-beam evaporation, followed by electrochemical deposition of the desired thickness of Pd (8 ML, 1.3 ML, 0.5 ML, 0.07 ML, or 0.04 ML) onto the Au substrate. 5CB liquid crystal was contacted with the resulting surfaces (and an Au only surface), and LC orientation was observed through a polarized-light microscope. The results are shown in FIG. 1.

As seen in FIG. 1, experimental anchoring measurements using 5CB show agreement with DFT predictions. Specifically, increasing Pd content on the Au surface causes 5CB to homeotropic ordering for Pd coverages above 0.07 ML Pd on Au host. Thus, such surfaces would be useful for LC-based detection of air contaminants having a more negative binding energy than LC on such surfaces.

### Example 3: LC-Based H₂ Detection on AuPd Alloys

In this example, we demonstrate detection of the contaminant H₂ using LC-based detection systems having AuPd metal alloy substrate surfaces.

We performed DFT calculations to determine the adsorption energy of hydrogen to the Pd surfaces disclosed in the previous example. As seen in Table 4, the model predicts that adsorbed hydrogen can bind strongly to Pd(111), which suggests that H₂ can be detected using this surface by dissociative adsorption.

TABLE 4
Binding Energies (eV) of Hydrogen and PhPhCN on Pd(111)

| Adsorption Equation | Adsorption Energies (eV) | Coverage |
|---|---|---|
| PhPhCN + * → PhPhCN * | −1.03 | 1/16 |
| H₂ (g) + * → 2H* | −1.21 | 1/16 |

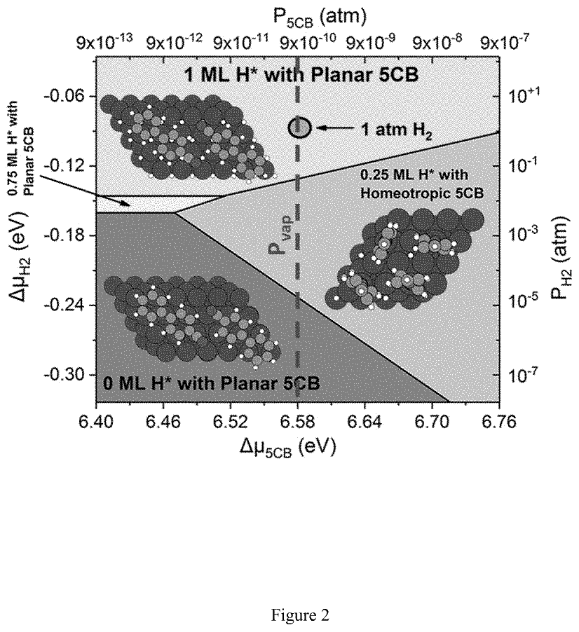

We extended this model by calculating a phase diagram for H₂ detection on Pd(111), with the results shown in FIG. 2. Experiments have shown that the lowest hydrogen pressure where planar anchoring is observed with LC on this surface is 100-1000 ppm H₂. This experimental result is within DFT error, showing that the DFT predictions are consistent with the experimental results presented below.

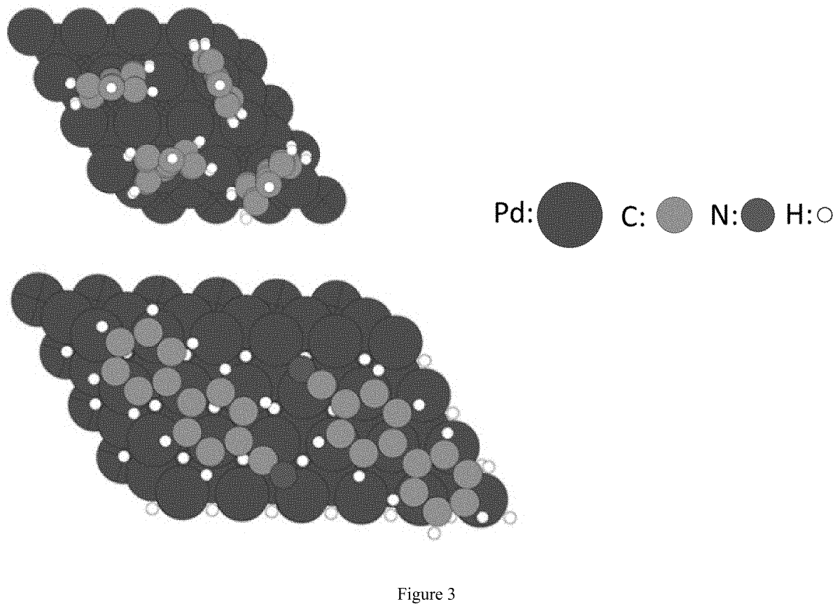

We performed simulations showing the favored anchoring/orientation configuration changes of 5CB (more precisely, its surrogate PhPhCN) as H is bound to the metal surface, switching from the homeotropic orientation at 0 ML H coverage (essentially no hydrogen atoms bound) to planar orientation at 1 ML coverage (essentially the entire surface covered by bound H) (see FIG. 3). Displacement of 5CB by adsorbed hydrogen atoms is the reason for the initial change in anchoring from homeotropic to planar under H₂ flow.

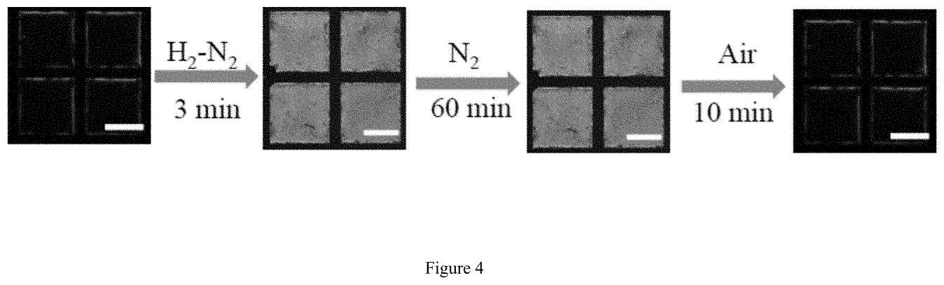

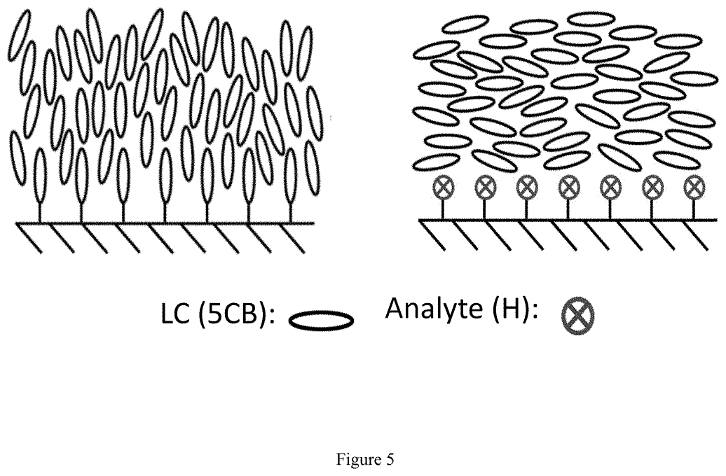

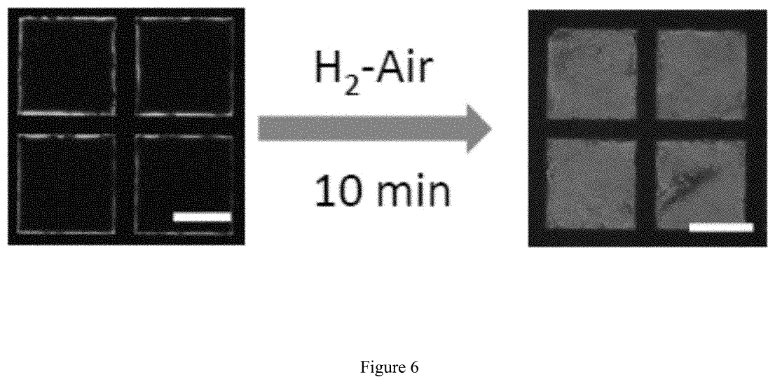

In an experimental confirmation of the DFT predictions, 5CB LC was disposed on a 0.07 ML Pd on Au substrate surface, resulting in homeotropic LC orientation (FIG. 4, left panel; FIG. 5, left panel). When exposed to 1000 ppm H₂ in a nitrogen atmosphere for three minutes, the LC orientation switched to planar (FIG. 5, second panel from left; FIG. 6, right panel). Upon subsequent exposure to a nitrogen atmosphere (without H₂) for 60 minutes, the LC maintained its planar orientation (FIG. 4, third panel from left). However, upon subsequent exposure to air for ten minutes, the LC orientation reversed back to homeotropic (FIG. 4, rightmost panel).

When a similar experiment was performed using 1000 ppm H₂ in air (instead of in a nitrogen atmosphere) using 5CB on the same metal substrate surface (0.07 ML Pd on Au), the response was significantly slower, requiring ten minutes of exposure for the 5CB to switch to planar orientation (FIG. 6 and FIG. 5). However, because hydrogen is explosive in air at 4% concentration (40,000 ppm), this setup was still able to detect hydrogen in air at ˜ 1/40^{th} of the explosive limit of H₂ pressure in air.

H₂ detection at 1000 ppm occurs much faster (within 3 minutes) in an N₂ atmosphere, but is irreversible in N₂, due to large recombinative desorption energy. The reversibility of such detection in air could be an advantage, in that it would allow reuse of detection devices designed to detect hydrogen in air.

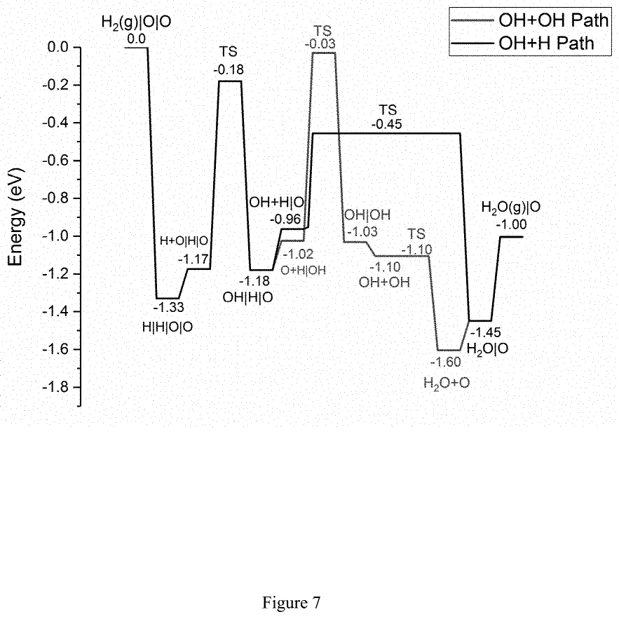

As illustrated in the reaction calculations below and in FIG. 7, the reaction of the adsorbed hydrogen on the metal surface with oxygen is thermodynamically favorable, making the H adsorption onto the surface reversible in air. While the barrier to form water on Pd(111) terrace sites is too high to occur at room temperature (1.18 eV), it can occur at step sites at temperatures as low as 250 K (see Mitsui et al., The Journal of Chemical Physics 2002, 117(12), 5855-5858).

$$Δ {E}_{displacement} = Δ {E}_{{H}_{2} , diss} * 2 - {BE}_{PhPhCN , ⊥} = - 1.63 eV$$

$$\begin{matrix}2 {H}^{*} -> {H}_{2} ( g ) + {2}^{*} & {ΔE}_{{H}_{2} , recomb - des} = + 1.33 eV \\ 2 {H}^{*} + 0.5 {O}_{2} -> {H}_{2} O ( g ) + {2}^{*} & Δ {E}_{{H}_{2} O form} = - 1.20 eV\end{matrix}$$

In sum, this example demonstrates that a LC-based device having a AuPd metal alloy substrate surface can be used to quickly and reversibly detect H₂ at concentrations far below the explosive limit.

### Example 4: LC-Based NO₂ Detection on AuPd Alloys

In this example, we demonstrate detection of the contaminant NO₂ using LC-based detection systems having AuPd metal alloy substrate surfaces.

We performed further DFT screening calculations to determine the binding strength of NO₂ to Pd(111), Pt(111), Au(111) and Ag(111) surfaces, for both molecular and dissociative adsorption of NO₂ on these surfaces. Our calculations were based on 1/16^{th} surface coverages and the dissociative adsorption energy of NO₂ (ΔE_{NO}_{₂}_{, diss}) is calculated with the following formulae:

$$Δ {E}_{N {O}_{2} , diss} = {E}_{NO *} + {E}_{O *} - 2 {E}_{substrate} - {E}_{{NO}_{2} ( g )}$$

where E_{NO*} is the total energy of the entire slab with 1/16^{th} ML NO adsorbed, E_{O*} is the total energy of the entire slab with 1/16^{th} ML O adsorbed, E_{substrate} is the total energy of the clean metal itself, and E_{NO}_{₂}_{(g)} is the total energy of the isolated NO₂ molecule in the gas phase.

As seen in Table 5, the model predicts that NO₂ molecular and dissociative adsorption is most favored on Pd(111). Thus, Pd is predicted to be the best metal to use as the substrate surface for LC-based NO₂ detection.

TABLE 5
Adsorption Energies (eV) for NO₂ and
PhPhCN on Four Different Metal Surfaces

| Adsorption Equation | Pd(111) | Pt(111) | Au(111) | Ag(111) |
|---|---|---|---|---|
| NO₂ (g) + * → NO₂* | −1.58 | −1.44 | −1.01 | −1.33 |
| NO₂ (g) + 2* → NO* + O* | −2.93 | −1.97 | +0.53 | +0.23 |
| Perpendicular PhPhCN | −1.11 | −1.27 | −0.45 | −0.54 |

*refers to surface bound species
Italics-Homeotropic LC orientation predicted
Bold-Planar LC orientation predicted

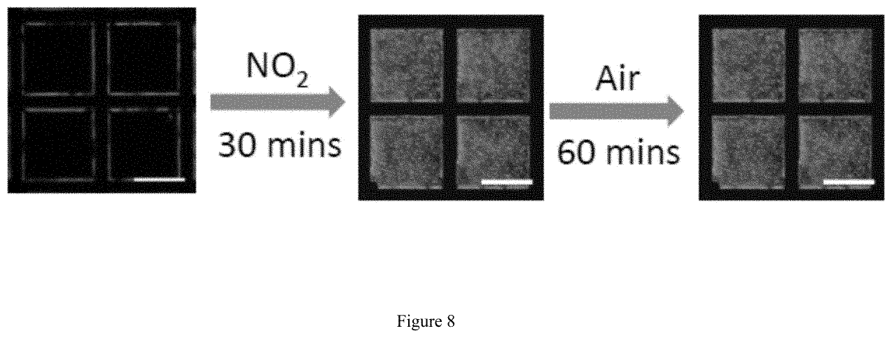

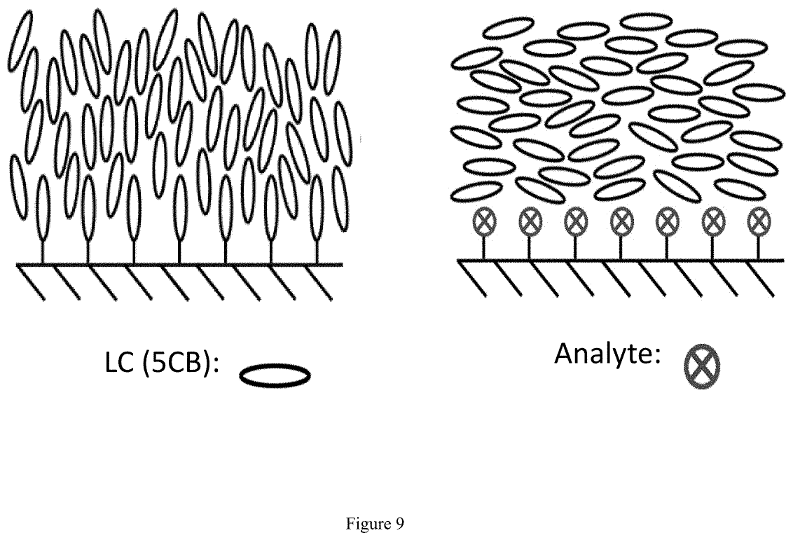

In an experimental confirmation of the DFT predictions, 5CB LC was disposed on a 0.07 ML Pd on Au substrate surface, resulting in homeotropic LC orientation (FIG. 8, left panel; FIG. 9, left panel). When exposed to 10 ppm NO₂ in a nitrogen atmosphere for 30 minutes, the LC orientation switched to planar (FIG. 8, center panel; FIG. 9, right panel). Upon subsequent exposure to air for 60 minutes, the LC maintained its planar orientation (FIG. 8, right panel).

In sum, this example demonstrates that a LC-based device having a AuPd metal alloy substrate surface can be used to quickly detect NO₂ at low concentrations.

### Example 5: LC-Based CO Detection on AuPd Alloys

In this example, we demonstrate detection of the contaminant CO using LC-based detection systems having AuPd metal alloy substrate surfaces.

We performed DFT calculations to determine the binding strength of CO to surfaces made up of Pd(111), Au(111), PdAu alloy having 1 ML Pd deposited on Au(111), and PdAu alloy having 0.07 ML Pd deposited on Au(111). Our calculations were based on 1/16^{th} surface coverages and a 4×4 unit cell.

As seen in Table 6, the model predicts that adsorbed CO can bind strongly to Pd(111). Because the CO binds more strongly to Pd surfaces than PhPhCN, this suggests that Pd-containing substrate surfaces can be used for LC-based detection of CO.

TABLE 6
Binding Energies (eV) of CO and PhPhCN on Four Different Metals

| Molecule | Pd(111) | Pd_{ML}/Au(111) | Pd_{0.07ML}Au(111) | Au(111) |
|---|---|---|---|---|
| Perpendicular | −1.03 | −1.11 | −0.97 | −0.45 |
| PhPhCN | | | | |
| CO | −2.27 | −2.53 | −1.43 | −0.43 |

The modeling was extended to predict LC anchoring at various CO on Pd surface coverages (0 ML, 0.25 ML, 0.50 ML, 0.75 ML, and 1 ML of CO adsorbed onto the Pd surface). PhPhCN was used as an LC surrogate. Note that a 0.05 eV change in the BE of PhPhCN will change the calculated results by 0.20 eV/nm². Calculations assume perpendicular binding in 4×4 unit cell with ¼^{th} ML PhPhCN surface coverage, parallel binding in 6×4 unit cell with 1/12^{th} ML PhPhCN surface coverage, and P_{5CB}=Pᵥₐₚ=1.06 ppb.

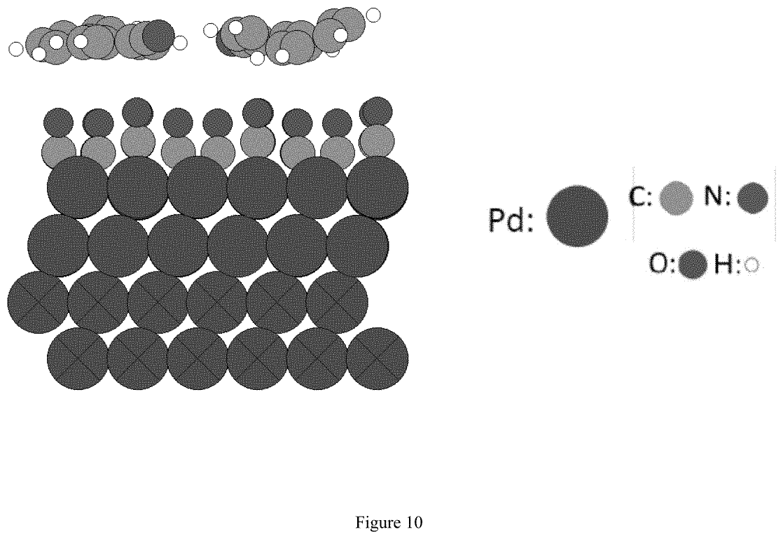

As seen in Table 7, the model predicts planar LC orientation (FIG. 10) with 0 and 0.75-1 ML of CO co-adsorbed, while lesser concentrations of CO co-absorbed (0.25 and 0.50 ML) are predicted to result in homeotropic LC orientation.

TABLE 7
PhPhCN Anchoring Predictions at Various CO Surface Coverages

| | Perpendicular | Parallel | |
|---|---|---|---|
| | PhPhCN | Binding | |
| | Binding Free | PhPhCN | |
| ML of CO | Energy | Binding Free | Predicted |
| co-adsorbed | (eV/nm²) | Energy (eV/nm²) | anchoring |
| 0 | −2.54 | −2.90 | Planar |
| 0.25 | −3.34 | −0.30 | Homeotropic |
| 0.50 | −2.88 | −0.20 | Homeotropic |
| 0.75 | −0.07 | −0.18 | Planar |
| 1 | +0.25 | −0.41 | Planar |

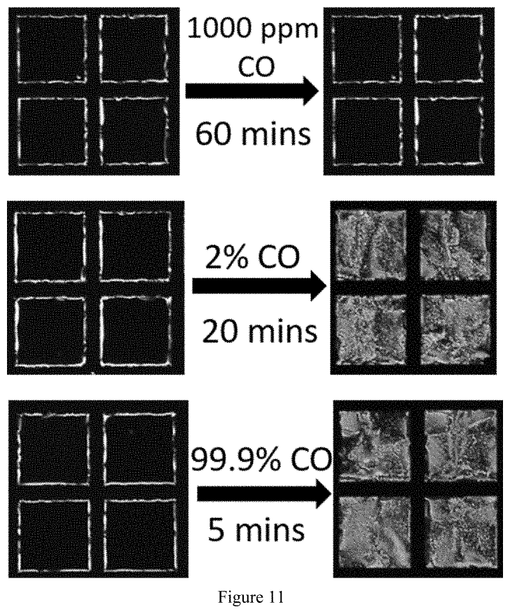

In a first experiment, 5CB was disposed on three 8 ML Pd on Au substrate surfaces, resulting in homeotropic LC orientation (FIG. 11, all three left panels). When exposed to 2% CO in a nitrogen atmosphere for 20 minutes (FIG. 11, center right panel) or 99.9% CO for 5 minutes (FIG. 11, lower right panel), the LC orientation switched to planar. However, when exposed to 1000 ppm CO in a nitrogen atmosphere for 60 minutes, the LC maintained its homeotropic orientation (FIG. 11, top right panel).

The OSHA Short Term Exposure Limit (STEL) for CO is 200 ppm in five minutes. Using 8 ML Pd on Au surface (essentially a Pd only surface), we could not detect CO below this limit (FIG. 11). To increase the sensitivity of CO detection, PdAu alloy surfaces may be used.

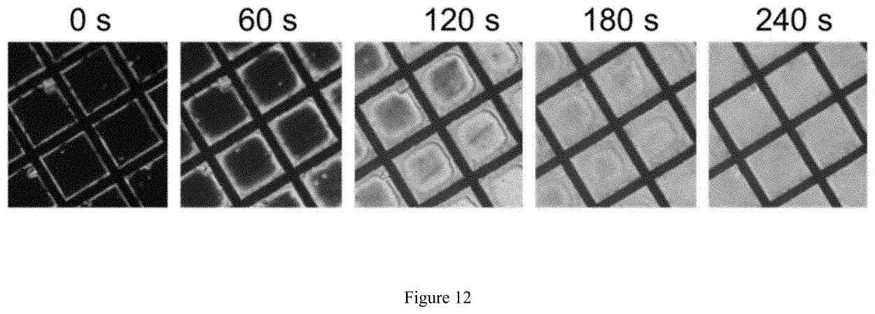

In a second experiment, 5CB LC was disposed on a 0.07 ML Pd on Au (PdAu alloy) substrate surface, resulting in homeotropic LC orientation (FIG. 12, left panel). When exposed to 1000 ppm CO in a nitrogen atmosphere, the LC orientation switches very quickly to planar, beginning with 60 seconds of exposure, with complete change seen at 180 seconds (FIG. 12).

In further experiments, we determined that we can detect CO at or below the OSHA limit using 0.07 ML Au on Pd as the substrate surface. Specifically, 200 ppm CO induced 5CB orientation change from homeotropic to planar within five minutes, while 100 ppm CO induced 5CB orientation change from homeotropic to planar within ten minutes.

In sum, this example demonstrates that a LC-based device having a AuPd metal alloy substrate surface can be used to detect CO at concentrations at or below the respective OSHA Short Term Exposure Limit.

### Example 6: LC-Based NH₃ Detection on AuPd Alloys and Method of Using One or More Dopants to Achieve Selective Contaminant Detection

In this example, we demonstrate detection of the contaminant NH₃ using LC-based detection systems having AuPd metal alloy substrate surfaces. Further, we demonstrate a method for achieving selective detection of a contaminant in an environment containing multiple contaminants, using the non-limiting example of NH₃ and CO.

In the previous examples, we demonstrated that LC-based devices can be used to detect multiple common contaminants. This creates a potential issue with contaminant selectivity, or the ability to design devices for detecting a given contaminant without interference from other contaminants that may be present in the sample. For example, the presence in a sample of a contaminant such as ammonia may create a false positive when testing for the presence of carbon monoxide.

To address this selectivity issue, one or more dopants may be added to the LC composition, or different LC hosts or LC mixtures could be used to tune the collective binding energy of the liquid crystal composition, so that a single contaminant can be detected within a sample containing multiple contaminants. To demonstrate this method further in a non-limiting example, we considered in detail the selective detection of CO in a sample that could contain both CO and NH₃, using a LC composition including a dopant added to a 5CB host

We first performed DFT calculations to determine the binding strength of CO, NH₃, and six different surrogate mesogen additives (dopants) to a surface made up of 1 ML Pd deposited on Au(111). The calculated binding energies (eV) are shown below, underneath the corresponding chemical structures. The structures are arranged in order from the weakest (least negative) binding energy to the strongest (most negative) binding energy.

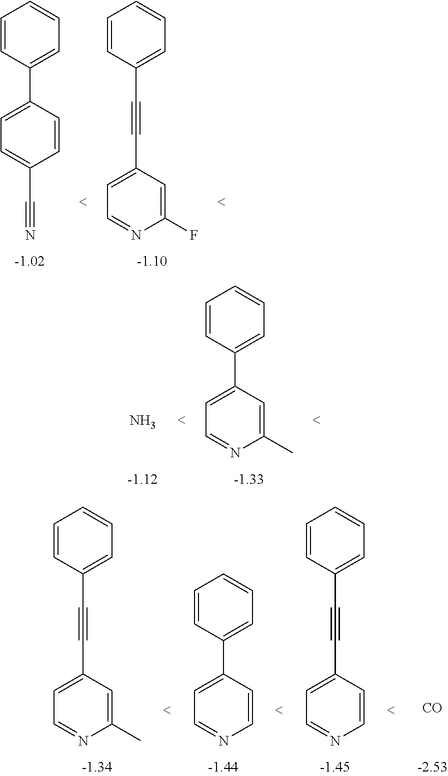

As seen in these calculations, four of the potential mesogen additives bind more strongly to this surface than NH₃, while still binding less strongly than CO. This suggests that they could be used as additives to form liquid crystal compositions that may be used with this surface to detect CO without detecting NH₃.

We next conducted experiments demonstrating that (1) LC-based detectors using 5CB can be used to detect NH₃, and (2) LC-based detectors using an LC composition including PD (4-(4-pentylphenyl)-pyridine) in a 5CB host can selectively detect CO without detecting NH₃.

We disposed 5CB LC on two identical 1.3 ML Pd on Au substrate surfaces, and an LC composition of 2 mole % PD in 5CB on two additional 1.3 ML Pd on Au substrate surfaces. PD has the chemical structure:

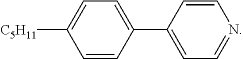

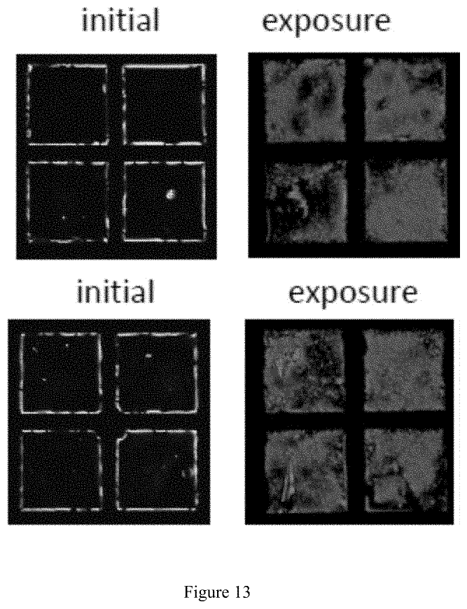

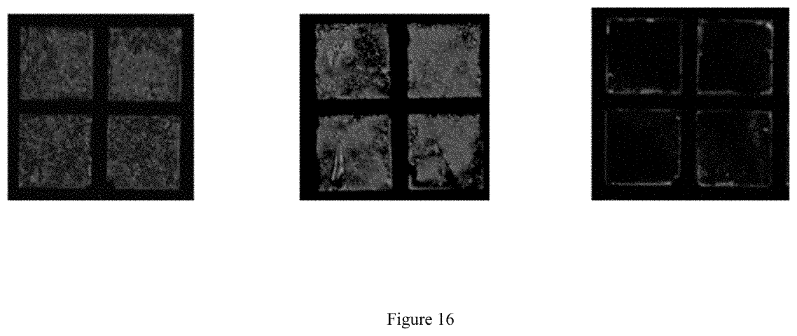

As expected, the LC in each of these setups initially exhibited homeotropic orientation (FIG. 13, upper left and lower left panels; FIG. 16, upper left and lower left panels). The first 5CB setup was exposed to 2% CO, which in ˜5 minutes resulted in a switch to planar orientation (FIG. 13, upper right panel). The first 2 mole % Pd in 5CB setup was also exposed to 2% CO, which in ˜5 minutes resulted in a switch to planar orientation (FIG. 13, lower right panel). These results are consistent with what was shown in the previous example.

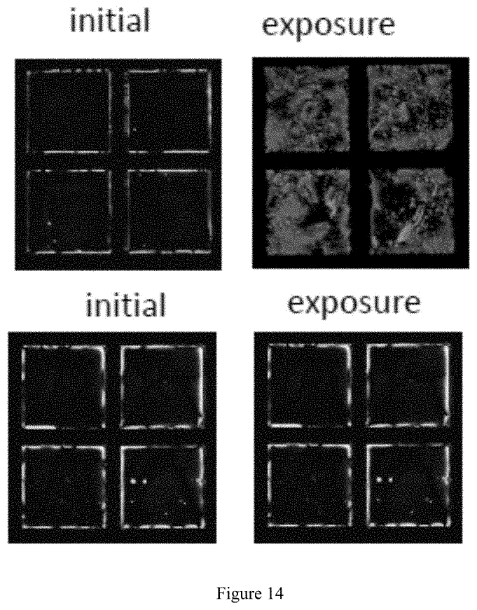

The second 5CB setup was exposed to 2% NH₃, which resulted in a switch to planar orientation (FIG. 14, upper right panel). Follow-up experiments were conducted using the same metal substrate surface and 5CB alone, showing that this setup can detect NH₃ at 25 ppm in 7 minutes, and that it can detect 5 ppm NH₃ in ˜30 minutes. Given that the OSHA Short Term Exposure Limit for NH₃ is 35 ppm in 15 minutes, this demonstrates that the disclosed LC-based devices can detect NH₃ at concentrations well below the allowed limit.

The second 2 mole % PD in 5CB setup was also exposed to 2% NH₃. In contrast to CO, exposure to NH₃ did not result in a change in LC orientation. Instead, the LC maintained its initial homeotropic orientations (FIG. 14, bottom right panel). This illustrates the potential of using LC compositions containing LC mixtures or one or more added dopants to facilitate more selective detection of a given contaminant.

We then performed further experiments demonstrating the selective detection of CO or NH₃ in a sample that may contain either or both contaminants. Specifically, 5CB alone and five different LC compositions including 2 mole % of five different dopants were disposed onto identical 1.3 ML Pd on Au substrate surfaces. These setups were then exposed to 2% CO or 2% NH₃. The six different LC compositions used in these experiments are listed below, along with the chemical structures of the five dopants and the 5CB host:

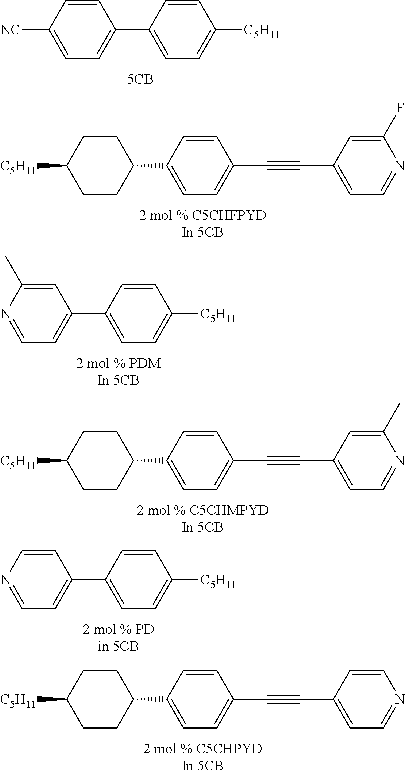

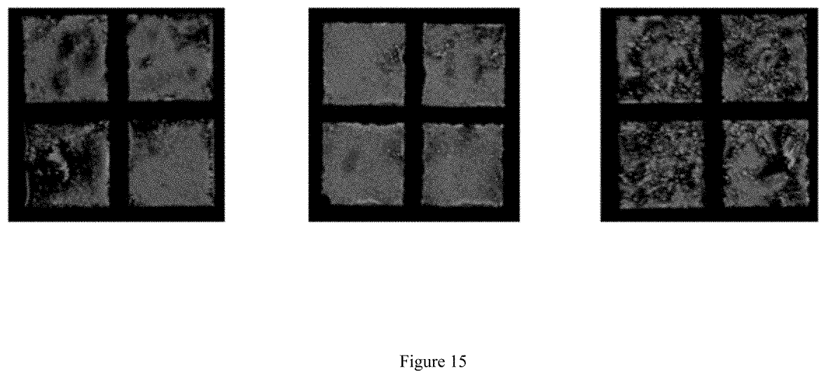

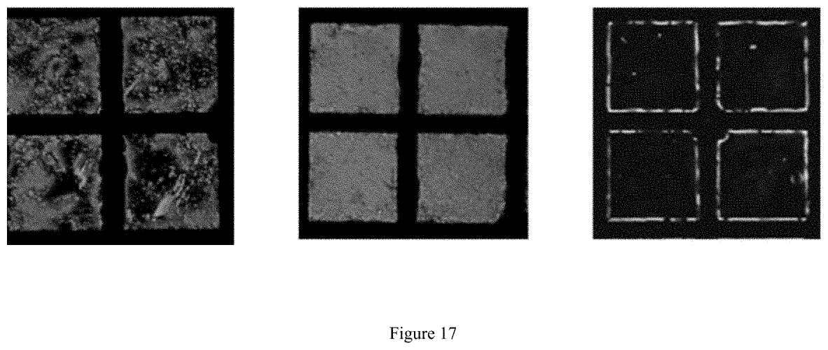

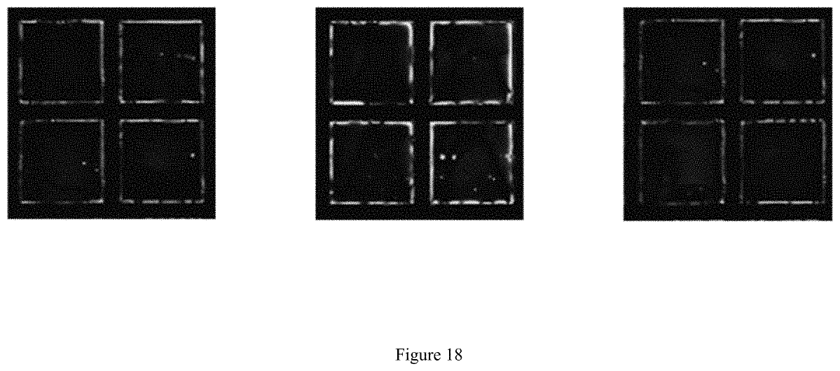

As seen in FIGS. 15 and 16, each of the LC compositions used switched to planar configuration on exposure to CO, except for the composition containing CSCHPYD as a potential dopant (FIG. 16, right panel). In contrast, as seen in FIGS. 17 and 18, only the LC composition containing 5CB and the composition containing CSCHFPYD as a potential dopant switched to planar configuration on exposure to NH₃ (FIG. 17, left and center panels, respectively). The remaining compositions maintained their initial homeotropic orientation on exposure to NH₃. Again, this illustrates the potential of using one or more dopants in the LC compositions to selectively detect a given contaminant in a sample.

Notably, C5CHPYD did not work as an effective dopant for selective detection, as the LC composition containing this molecule did not respond to either analyte. Our preliminary data indicates that longer molecules or molecules containing the characteristic central triple C—C bond of tolenes (such as C5CHPYD) may not work as well as potential dopants as other molecules. In addition, surfaces made of a submonolayer of Pd on Au (<1 ML Pd on Au) will not work well with this method, because the molecules will bond strongly to the exposed Au surface.

In sum, this example shows that the disclosed LC-based detection systems can be used to detect NH₃ at concentrations well below OSHA exposure limits, and also demonstrates a method for increasing the selectivity of the disclosed devices for a given contaminant by using a LC composition having one or more added dopants.

### Example 7: LC-Based CO Detection on Pt Metal and Method to Improve Response Time Using a Chemically Reactive Chemical Sensitizer

In this example, we demonstrate detection of the contaminant CO using LC-based detection systems having a Pt metal substrate surface. Further, we demonstrate a method for achieving faster detection of a contaminant with a non-limiting example using CO as the target contaminant and O₃ as a chemical sensitizer.

We performed DFT screening calculations to determine the binding strength of H and CO analytes and the LC surrogate PhPhCN to a Pt(111) surface at low ( 1/16^{th}) surface coverage. As seen in Table 8, the model predicts that adsorbed CO can bind strongly to Pt(111). Because the CO binds more strongly to the Pt surface than PhPhCN, this suggests that Pt-containing substrate surfaces can be used for LC-based detection of CO.

TABLE 8
Binding Energy of CO, H and PhPhCN on Pt(111)

| Molecule | Binding Energy (eV) | Coverage |
|---|---|---|
| Perpendicular PhPhCN | −1.20 | 1/16 |
| H | −2.81 | 1/16 |
| CO | −2.05 | 1/16 |

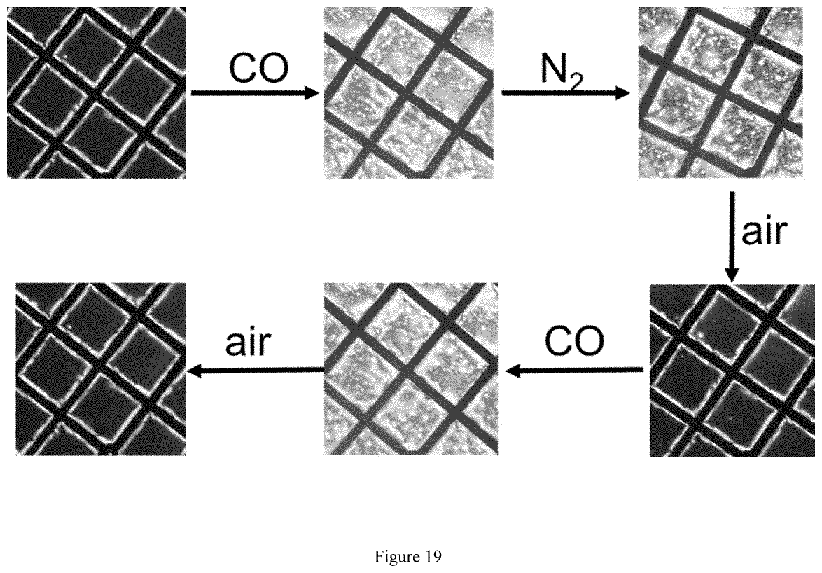

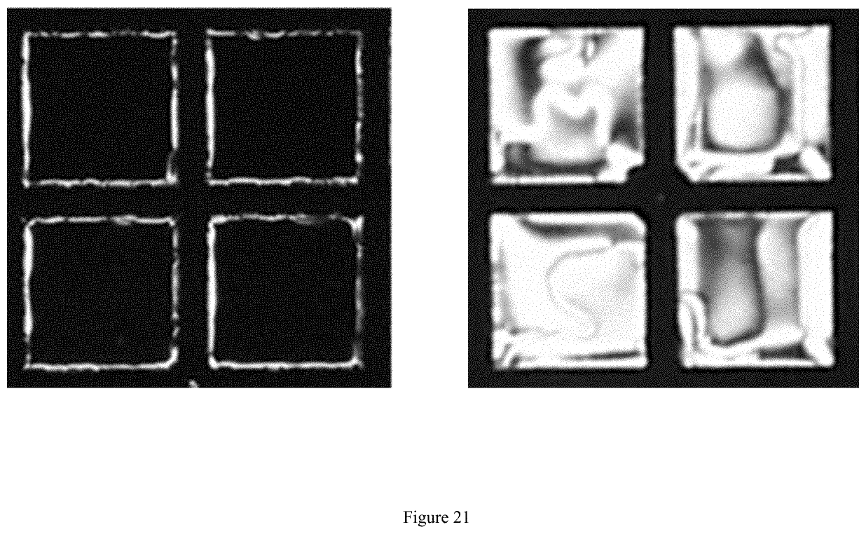

To test this prediction experimentally, we disposed 5CB LC on a Pt film produced by e-beam deposition. As expected, the LC initially exhibited homeotropic orientation (FIG. 19, upper left panel). The setup was then exposed to 2% CO in N₂, which resulted in a switch to planar orientation (FIG. 19, upper center panel). The response time was 50 minutes on exposure to 2% CO and was not reversed upon subsequent exposure to nitrogen (FIG. 21, upper right panel), but was reversed on exposure to air (FIG. 19, lower panels). In further experiments, we determined that the response time on exposure to pure CO was five minutes.

These results were consistent with what was reported in Example 5 using Pd surfaces, except that when using the competitive adsorption detection method, response times for CO detection on Pt were very slow as compared to response times obtained using a Pd surface. Accordingly, we developed a method using pretreatment of the surface with a chemically reactive chemical sensitizer (in this example, 03) to obtain faster response times. In this non-limiting example, the chemical sensitizer itself binds to the metal substrate surface, and reacts when contacted with the target contaminant, thus being released from the metal substrate surface and changing the orientation of the LC.

We performed further DFT calculations to predict the anchoring configuration of LC to a metal Pt(111) surface that is pretreated with O₃. O₃ oxidizes the Pt by forming oxygen atoms that are co-adsorbed onto the metal surface:

$${O}_{3} ( g ) + * -> {O}^{*} + {O}_{2} ( g ) Δ E = - 2.46 eV \\ ( 1 / {4}^{th} coverage of absorbed O on Pt ( 111 ) in 2 \times 2 unit cell )$$

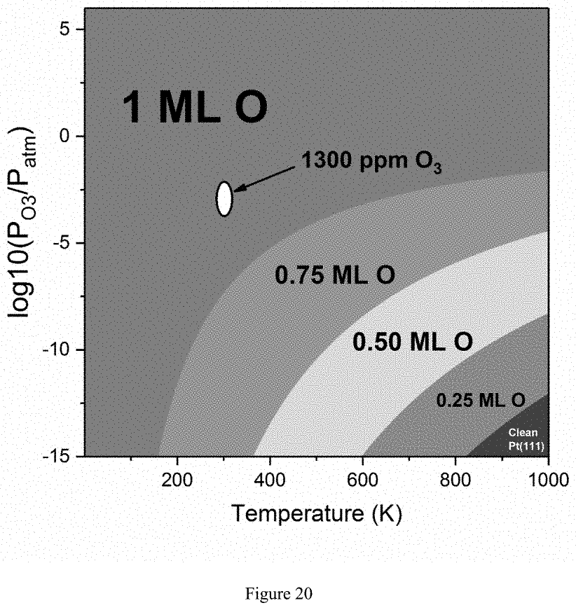

As seen in the phase diagram shown in FIG. 20, complete 0 (1 ML) surface coverage is expected upon exposure to 1300 ppm 03. As shown further in Table 9, such surface coverage should cause planar LC anchoring on the pretreated Pt surface. The calculations assume P_{5CB}=Pᵥₐₚ=1.06 ppb. LC Molecular Tail Corrections are, for H(omeotropic) anchoring, −0.43 eV/PhPhCN; and for P(lanar) anchoring, −0.25 eV/PhPhCN.

Beginning with this predicted planar “pretreated with chemical sensitizer” orientation, such surfaces can be used in alternative detection schemes that depend on a chemical reaction of the chemical sensitizer (in this case, bound to the surface as 0 atoms) with a potential analyte, such as CO, to trigger a change in the orientation of the LC, rather than depending on competitive adsorption of the analyte.

TABLE 9
Binding Free Energies and Predicted LC Anchoring
Orientation on Pt(111) with O Co-Adsorbed Onto Surface

| | Perpendicular | Parallel Binding | |
|---|---|---|---|
| | PhPhCN Binding | PhPhCN Binding | |
| ML of Oxygen | Free Energy | Free Energy | Predicted |
| co-adsorbed | (eV/nm²) | (eV/nm²) | anchoring |
| 0.25 | −2.60 | −1.09 | Homeotropic |
| 1 | +0.42 | −0.16 | Planar |

Our experiments confirmed these predictions. Exposure of 5CB disposed on Pt film with 1300 ppm O₃ in air resulted in a planar LC orientation (FIG. 21).

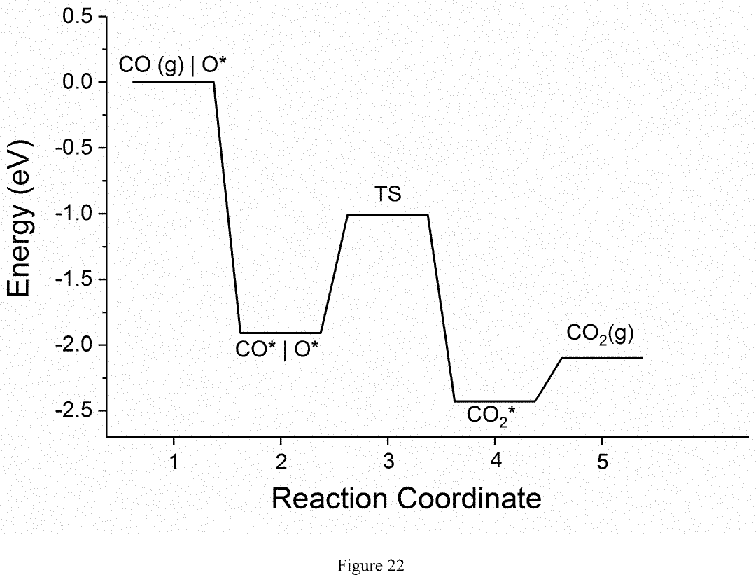

As shown in FIG. 22, the reaction of the co-adsorbed O with CO to form CO₂ is thermodynamically favored (calculated with a 2×2 unit cell for clean Pt(111) without PhPhCN).

CO(g)+O*→*+CO₂(g)ΔE=−2.10 eV

For ¼^{th} coverage adsorbed O in 2×2 unit cell of Pt(111)

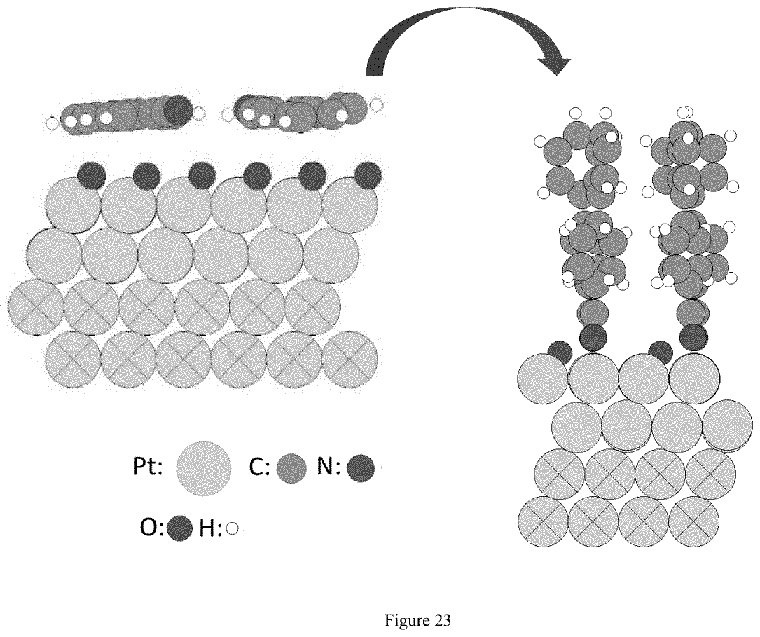

While CO oxidation on clean Pt(111) has a barrier of 0.90 eV, which is still larger than what can occur at room temperature, this barrier decreases at higher oxygen coverages. We do not need to remove all adsorbed O to observe a response. If the reaction with CO removes a sufficient amount of adsorbed O, the LC will switch from planar orientation to homeotropic (FIG. 23).

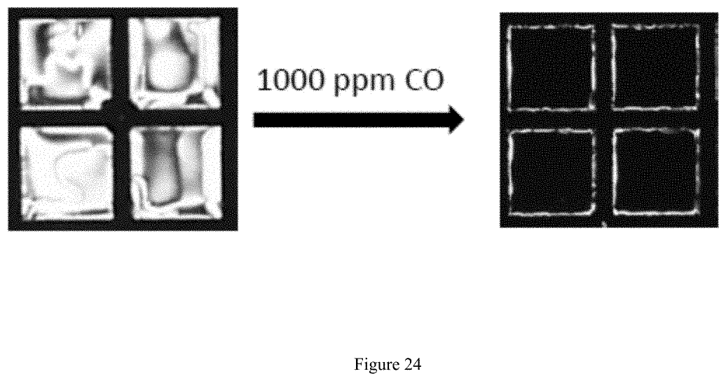

Follow-up experiments were conducted to confirm that CO could be detected by reducing surface oxygen coverage, as predicted by the model. 5CB disposed onto a Pt film pretreated with 1300 ppm O₃, as described above was exposed to 200-1000 ppm CO in N₂. As a result, the LC switched from planar to homeotropic orientation (FIG. 24). The response time varied from 1 minute, for 1000 ppm CO exposure, to 7 minutes, for 200 ppm CO exposure. This response time was much quicker than what we observed with Pt film using the displacement mechanism, as we described earlier in this example. Accordingly, these experiments provide proof of concept that in addition to the simple displacement of LC on the surface, a chemical reaction of the target contaminant with a chemical sensitizer within the detection system can also form the basis of LC-based detection of the target contaminant.

In sum, this example shows that the CO can be detected using LC-based detection systems having Pt metal substrate surfaces, either by a LC displacement mechanism where the CO displaces the LC on the metal substrate surface, or by chemically reacting with a chemical sensitizer within the system (e.g., O₃/O*) to change the orientation of the LC.

### Example 8: LC-Based O₃ Detection on Au

In this example, we demonstrate detection of the contaminant O₃ using LC-based detection systems having Au metal substrate surfaces.

As with Pt, our model predicts that will O₃ will strongly bind to Au metal surfaces.

O₃(g)→O*+O₂(g)ΔE=−1.41 eV

For ¼^{th} coverage adsorbed O on Au(111) in 2×2 unit cell

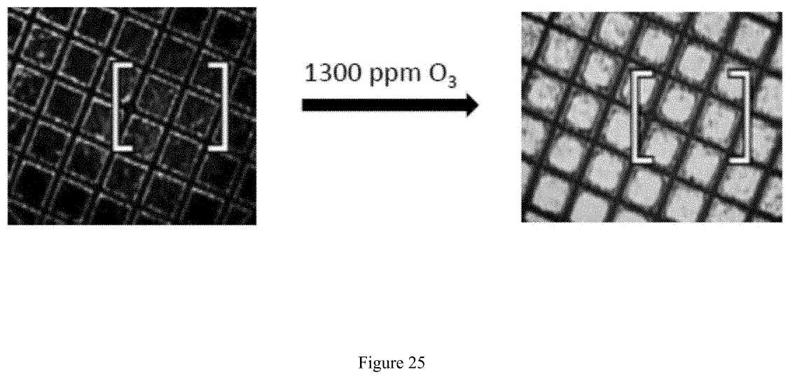

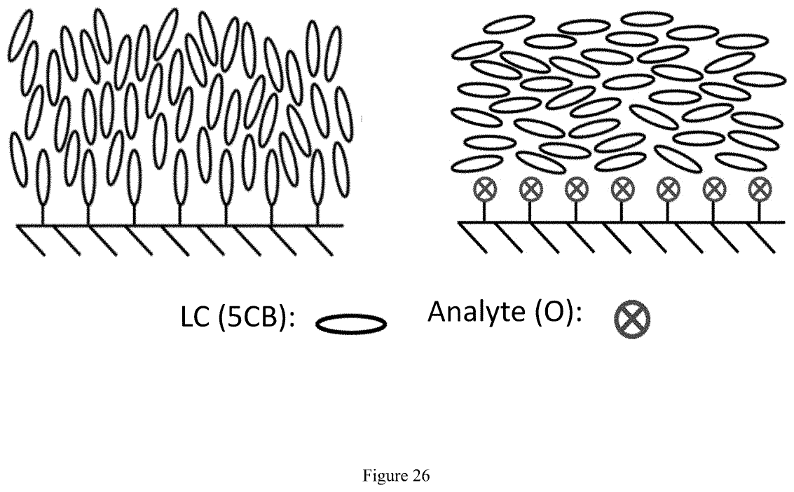

A liquid crystal composition containing 0.0005 mol % CBCA dopant in 5CB was disposed on a 20 nm Au film formed by e-beam evaporation. The LC composition initially exhibited homeotropic orientation (FIG. 25, left panel, and FIG. 26, left panel). CBCA has the chemical structure:

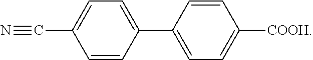 [SMILES: N#Cc1ccc(-c2ccc(C(=O)O)cc2)cc1]

Upon exposure to 1300 ppm O₃, the LC composition switched to planar orientation (FIG. 25, right panel), as the LC was displaced by the adsorbed O (FIG. 26, right panel). The OSHA Short Term Exposure Limit for O₃ is 0.3 ppm for 15 minutes. Although we have not yet tested lower concentrations of O₃, the very quick one-minute response time shown in this experiment shows promise that it would be possible to tune this detection system to meet this limit.

In sum, this example demonstrates that a LC-based device having a Au metal substrate surface and a LC composition containing a dopant can be used to successfully detect O₃.

### Example 9: Relevant Cases with No Response on AuPd Alloys

In systems and methods for detecting certain target contaminants in air, it is important that there is no response to substances that are normally present in air, such as oxygen, nitrogen, or water vapor. Furthermore, it is an advantage if there is no response to other environmental hazards for which air is commonly tested, such as volatile organic compounds (VOCs). In this example, we demonstrate that LC-based detection systems using AuPd alloy substrate surfaces do not respond to such analytes.

Our model predicts that water binds very weakly to metal surfaces used in these examples, such as Au or Pd.

$$B {E}_{{H}_{2} O , Au ( 111 )} = - 0.31 eV$$

$$B {E}_{{H}_{2} O , Pd ( 111 )} = - 0.47 eV$$

This means that the displacement methods of containment detection disclosed in these examples should not show a response to water vapor, even to high levels of humidity. This is good, as humidity is everywhere and responses to it would lead to false positives for the target contaminant.

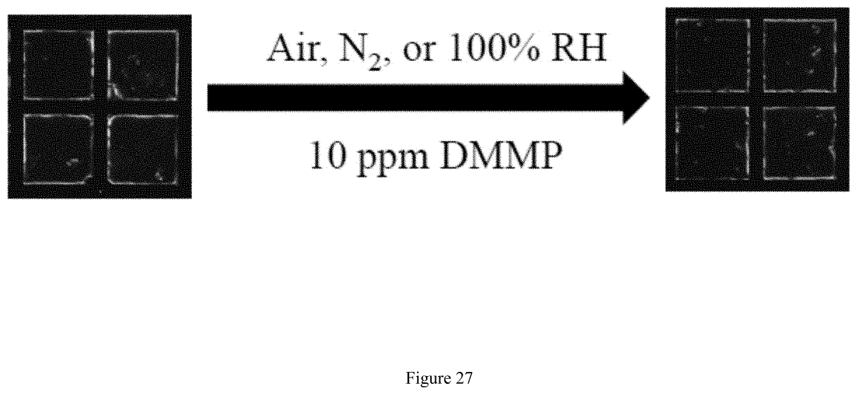

To experimentally confirm that water and other relevant analytes in air would not trigger a response in the disclosed LC-based systems and methods, we exposed 5CB disposed onto 0.07 ML Pd on Au surfaces to Air, N₂, 100% humidity (water vapor), or 10 ppm DMMP. No response was in any of these cases after one hour of continuous exposure (FIG. 27). These results confirm that non-contaminants and other environmental toxins often found in air will not interfere with the methods of LC-based detection of target contaminants disclosed in this application.

This invention is not limited to the examples or embodiments set forth in this disclosure for illustration but includes everything that is within the scope of the claims.

1. A device for detecting one or more target analytes, the device comprising:
(a) a substrate having a surface comprising a metal or metal alloy: and
(b) a liquid crystal composition comprising one or more liquid crystals in contact with the substrate surface, wherein the liquid crystal composition is capable of changing its orientational ordering when the target analyte comes in contact with the substrate surface, and wherein the target analyte is selected from the group consisting of hydrogen, carbon monoxide, ammonia, nitrogen dioxide and ozone.

2. The device of claim 1, wherein the change in orientational ordering of the liquid crystal is a change in the orientation of the easy axis of the liquid crystal.

3. The device of claim 1, wherein the substrate surface is capable of either:
(i) binding the liquid crystal composition strongly enough to cause homeotropic ordering of the liquid crystal composition when in contact with the substrate surface in the absence of the target analyte, but not when the target analyte is bound to the substrate surface; or
(ii) interacting with a chemical sensitizer that is capable of chemically reacting with the target analyte, such that the orientational ordering of the liquid crystal composition when in contact with the substrate surface in the presence of the chemical sensitizer and in the absence of the target contaminant is different than when in the presence of both the chemical sensitizer and the target analyte.

4. The device of claim 1, wherein the liquid crystal composition further comprises a dopant.

5.-7. (canceled)

8. The device of claim 3, further comprising the chemical sensitizer in contact with the substrate surface.

9.-27. (canceled)

28. The device of claim 1, wherein the substrate surface comprises one or more noble metals or mixtures of noble metals.

29. The device of claim 28, wherein the noble metals are selected from the group consisting of gold, palladium, platinum, and mixtures thereof.

30.-32. (canceled)

33. A method for detecting the presence of one or more target analytes in a sample, the method comprising:
(a) contacting the device according to claim 1 with the sample; and
(b) observing the orientational ordering of the liquid crystal composition in the device;
wherein an observed change in the orientational ordering of the liquid crystal composition indicates that the target analyte is present in the sample, and wherein the target analyte is selected from the group consisting of hydrogen, carbon monoxide, ammonia, nitrogen dioxide and ozone.

34. The method of claim 33, wherein the observed change in orientational ordering that indicates the presence of the target analyte in the sample is a change in the tilt angle of the liquid crystal relative to the substrate surface.

35. (canceled)

36. The method of claim 34, where the device further comprises a chemical sensitizer in contact with the substrate surface that is capable of chemically reacting with the target analyte.

37.-38. (canceled)

39. The method of claim 33, further comprising quantifying the amount of the target analyte in the sample, wherein the quantity of target analyte in the sample is correlated with the speed or extent of the observed change in orientational ordering.

40. The method of claim 33, wherein the substrate surface of the device comprises a noble metal or a mixture of noble metals.

41. (canceled)

42. The method of claim 33, wherein the device further comprises a chemical sensitizer in contact with the substrate surface that is capable of interacting with the substrate surface and capable of chemically reacting with the target analyte.

43.-46. (canceled)

47. A method for detecting the presence of one or more target analytes in a sample, the method comprising:
(A) contacting the sample with a device comprising:
(1) a substrate having a surface comprising a metal or metal alloy: and
(2) a liquid crystal composition comprising one or more liquid crystals in contact with the substrate surface; and
(B) observing the orientational ordering of the liquid crystal composition in the device;
wherein an observed change in the orientational ordering of the liquid crystal composition indicates that the target analyte is present in the sample, and wherein the target analyte is selected from the group consisting of hydrogen, carbon monoxide, ammonia, nitrogen dioxide and ozone.

48. The method of claim 47, wherein the substrate surface of the device is capable of either:
(a) binding the liquid crystal composition strongly enough to cause homeotropic ordering of the liquid crystal composition when in contact with the substrate surface in the absence of the target analyte, but not when the target analyte is bound to the substrate surface; or
(b) interacting with a chemical sensitizer that is capable of chemically reacting with the target analyte, such that the orientational ordering of the liquid crystal composition when in contact with the substrate surface in the presence of the chemical sensitizer and in the absence of the target contaminant is different than when in the presence of both the chemical sensitizer and the target analyte.

49. The method of claim 47, wherein the observed change in orientational ordering that indicates the presence of the target analyte in the sample is a change in the tilt angle of the liquid crystal relative to the substrate surface.

50. (canceled)

51. The method of claim 49, where the device further comprises a chemical sensitizer in contact with the substrate surface that is capable of interacting with the substrate surface and that is capable of reacting with the target analyte.

52.-53. (canceled)

54. The method of claim 47, further comprising quantifying the amount of the target analyte in the sample, wherein the quantity of target analyte in the sample is correlated with the speed or extent of the observed change in orientational ordering.

55. The method of claim 47, wherein the substrate surface of the device comprises a noble metal or a mixture of noble metals.

56.-60. (canceled)

61. A method for optimizing the device of claim 1 to maximize its selectivity for, sensitivity for, or detection speed for a given target analyte, the method comprising:
(a) contacting a device according to claim 1 with a composition comprising the target analyte;
(b) observing the orientational ordering of the liquid crystal composition in the device to determine its selectivity for, sensitivity for, or detection speed for the target analyte;
(c) altering the device in one or more ways;
(d) contacting the altered device with a composition comprising the target analyte; and
(e) observing the orientational ordering of the liquid crystal composition in the device to determine how its selectivity for, sensitivity for, or detection speed for the target analyte was changed.

62.-67. (canceled)
